(19) United States
(12) Patent Application Publication
(10) Pub. No.: US 2016/0138174 A1
(43) Pub. Date: May 19, 2016

(54) Electrochemically Responsive Composites of Redox Polymers and Conducting Fibers

(71) Applicant: Massachusetts Institute of Technology, Cambridge, MA (US)

(72) Inventors: T. Alan Hatton, Sudbury, MA (US); Xianwen Mao, Cambridge, MA (US); Gregory C. Rutledge, Newton, MA (US); Wenda Tian, Cambridge, MA (US); Jie Wu, Cambridge, MA (US)

(21) Appl. No.: 14/942,221

(22) Filed: Nov. 16, 2015

Related U.S. Application Data
(60) Provisional application No. 62/079,951, filed on Nov. 14, 2014.

(51) Int. Cl. C25B 3/02; C25B 3/00; C25B 3/04; H01B 1/12

(52) U.S. Cl. CPC C25B 3/02; H01B 1/125; C25B 3/00; C25B 3/04

(57) ABSTRACT

Disclosed are composite compositions, comprising a conductive matrix and an electrochemically active polymer, which are useful as heterogeneous catalysts or charge-storage materials. Suitable electrochemically active polymers include redox polymers, such as polyvinylferrocene, and conducting polymers, such as polypyrrole, and interpenetrating networks containing both redox polymers and conducting polymers.

### RELATED APPLICATIONS

This application claims the benefit of priority to U.S. Provisional Patent Application Ser. No. 62/079,951, filed Nov. 14, 2014, the contents of which are hereby incorporated by reference.

### BACKGROUND

Redox polymers are localized state conductors, containing redox active units, that can undergo reversible redox reactions in response to electrochemical stimuli. The electronic charge transport within redox polymers is achieved via mutual electron transfer between two adjacent redox centers. The redox centers, when fixed, must be sufficiently close to each other for electron hopping to occur. Electron transport in redox polymers has been modeled as a diffusion-like process, and this process requires the coincident counter-ion diffusion within the film to assure electroneutrality throughout the film. Therefore, the oxidation and reduction of the redox centers relies on both electron transport and ion diffusion within the polymer film.

In stimuli-responsive systems, external signals can be exploited to regulate material properties. As an example, chemists have recently begun to incorporate control elements into catalyst design in response to an increasing interest in responsive catalytic systems. Such systems enable new strategies for the modulation of reaction kinetics using various chemico-physical stimuli. The key to achieving stimuli-controlled catalysis is the development of a system in which the concentration or accessibility of the catalytic site in reaction media can be adjusted in response to external signals, such as temperature, pH, solvent composition, or redox potential. In most cases, the catalyst carrier (usually a soft material, such as a polymeric gel) undergoes morphological and/or architectural changes upon exposure to an external stimulus that results in variations in the catalyst concentration and/or accessibility. In one example, a thermoresponsive gel was used to move the catalyst into or out of the reaction medium, thus turning the reaction on or off at will. In another case, temperature or pH was used to de-swell a hydrogel, thereby concentrating the catalyst within the gel matrix and accelerating the reaction rate.

Polyvinylferrocene (PVF) has been studied as a model redox polymer for many applications. It contains an unconjugated backbone with covalently attached redox active ferrocene units as pendant groups. Though not conducting, electrons can sequentially transfer via electron hopping between neighboring ferrocene moieties, thus inducing oxidation and reduction reactions under electrochemical stimulus. Compared to other redox polymers, PVF is highly stable, and its simple, one-electron redox reaction is fast. However, despite all of its favorable properties PVF has rarely been explored for applications such as energy storage because of its low intrinsic conductivity. In addition, while close packing of polymers can increase the redox center concentration and hence reduce the inter-site distance for fast electron hopping, it usually also results in a nonporous structure with limited polymer/electrolyte interface that hinders ion diffusion. The compromise between electronic and ionic conductivity lowers the redox center utilization efficiency and makes it challenging to achieve the theoretical specific capacitance.

Therefore, there is a need for compositions exhibiting tunable reactivity to electrochemical potential for catalytic or energy storage applications.

### SUMMARY

In certain embodiments, the invention relates to a composite material, comprising a conductive matrix; and an electrochemically active polymer.

In certain embodiments, the invention relates to any of the composite materials described herein, wherein the electrochemically active polymer is a conducting polymer.

In certain embodiments, the invention relates to any of the composite materials described herein, wherein the electrochemically active polymer is a redox polymer.

In certain embodiments, the invention relates to any of the composite materials described herein, wherein the electrochemically active polymer comprises a conducting polymer and a redox polymer.

In certain embodiments, the invention relates to any of the composite materials described herein, wherein the conductive matrix is conformally coated with the electrochemically active polymer.

In certain embodiments, the invention relates to a method of catalyzing a chemical transformation of a starting material to a product, comprising the steps of:
contacting in an electrochemical cell the starting material with any of the composite materials described herein, thereby forming a reaction mixture;
applying to the reaction mixture an electrochemical potential, thereby forming a quantity of the product; and
after a period of time, removing the electrochemical potential.

In certain embodiments, the invention relates to a method, comprising the steps of:

contacting in an electrochemical cell a conductive matrix with (i) an electrochemically active polymer, (ii) an electro-polymerizable monomer that, once polymerized, forms an electrochemically active polymer, or (iii) both (i) and (ii), thereby forming a deposition mixture; and

applying to the deposition mixture an electrochemical potential, thereby (i) depositing onto the conductive matrix the electrochemically active polymer, (ii) depositing onto the conductive matrix an electrochemically active polymer derived from the electro-polymerizable monomer, or (iii) depositing onto the conductive matrix a hybrid polymer.

### BRIEF DESCRIPTION OF THE FIGURES

FIG. 1 has three panels (a-c). Panel a is a conceptual drawing of an ERHC system composed of interconnected conductive fibers (CFs) that are conformally coated with redox-switchable catalysts. Panel b depicts a schematic illustration of electrochemical control over the number of active sites and reaction rates. When the applied potential (E) on the conductive framework is much lower than the formal potential (E⁰) of the redox-switchable catalyst, most catalytic sites are deactivated and thus the reaction is slow. When E>>E⁰, most catalytic sites are activated and thus the reaction is fast. Panel c depicts a comparison between ERHC (circles) and “on/off” bimodal responsive catalysis (dashes) for kinetic control. In “on/off” bimodal catalysis, variations of external signals usually make reactions either fast or slow (line). In contrast, in an ERHC system, electrochemical potential can be employed to modulate the reaction rate continuously and thus achieve intermediate rates (circles).

FIG. 2 has four panels (a-d). Panel a depicts schematics of oxidation-induced conformal deposition of PVF onto CFs. Panel b depicts cyclic voltammograms (CVs) of a bare and a PVF-coated CF matrix. Scan rate: 50 mV/s. Electrolyte: 0.5 M NaClO₄. Panel c depicts XPS spectra of a bare and a PVF-coated CF matrix. Panel d depicts ferrocene surface coverage versus deposition time. Insets: corresponding SEM images of the specimens. Scale bar: 2 μm.

FIG. 3 has six panels (a-f). Panels a and b depict large-area SEM images of unmodified CFs. Scale bar: 10 μm. Panels c and d depict large-area SEM images of PVF-coated CFs after 10 min deposition. Scale bar: 10 μm. Panels e and f depict large-area SEM images of PVF-coated CFs after 30 min deposition. Scale bar: 10 μm.

FIG. 4 has three panels (a-c). Panel a depicts Fe mapping and corresponding SEM images of PVF-coated CFs (after 10 min deposition). Scale bar: 10 μm. Panel b depicts Fe mapping and corresponding SEM images of unmodified CFs. Scale bar: 10 μm. Panel c depicts Fe mapping, C mapping, and corresponding SEM images of the cross-section of cryo-fractured PVF-coated CFs (after 10 min deposition). Scale bar: 10 μm.

FIG. 5 has three panels (a-c). Panel a depicts a schematic showing the starting materials and products of the Michael addition reaction between methyl vinyl ketone and ethyl t-oxo-cyclopentane carboxylate. Panel b depicts a plot of ln m versus t for the Michael addition reaction of panel a measured in the presence of a PVF/CF system prepared by 10 min potentiostatic deposition when 0.8 V and 0.0 V were applied. Different symbols indicate three independent measurements. Panel c depicts a plot of kₐₚₚ (bars) and k_{N} (line) as a function of potential for the Michael addition reaction.

FIG. 6 has six panels (a-f). Panel a depicts experimentally determined Iₚ (circle) with vₛ=0.05, 0.10, 0.15, 0.20, 0.25, and 0.30 V/s for PVF-coated CFs (after 10 min deposition). The black solid line is the linear fitting for ln Iₚ versus ln vₛ. Panel b depicts a schematic illustration of the RPR model. Curved arrows indicate the electron exchange at the electrode/polymer interface. Straight arrows indicate the diffusional charge transfer process in the bulk film. Panel c depicts a plot of simulated ln Iₚ−ln vₛ relationships with different Lₘₐₓ values. Lₘₐₓ increases from 1 to 67 with the arrow direction. Dash lines indicate the two limiting cases. Panel d depicts a plot of S_{IV} versus Lₘₐₓ. These values were calculated from linear fitting of the simulated ln Iₚ−ln vₛ data in panel c. The slope decreases with increasing Lₘₐₓ, and a Lₘₐₓ value of 36 yields the S_{IV} value (0.66) experimentally observed for the PVF/CF catalyst. Panel e depicts a plot of simulated Iₚ values (square) when Lₘₐₓ=1 and vₛ ranges from 0.001 to 0.02 V/s. The black solid line is the linear fitting for ln Iₚ versus ln vₛ, which yielded an S_{IV} value of 1.00, thus confirming the validity of this model. Panel f depicts a plot of film thickness (circle) and Lₘₐₓ (square) as a function of d_{IL}. With an increasing d_{IL} value, although the Lₘₐₓ value required to achieve the experimentally observed S_{IV} value decreased significantly from 86 to 17, the thickness of the film (i.e., d_{IL}×Lₘₐₓ) was similar, ranging from 68 to 84 nm (circle), consistent with the thick thickness (62 nm) determined by neutron reflectivity for a PVF film with a similar ferrocene surface coverage.

FIG. 7 depicts a plot of the concentration of MVK (circle) in a batch reactor as a function of time in the presence of a PVF/CF hybrid (10 min deposition), whose electrochemical potential was programmed to be 0.8 V (completely oxidized state) from 0 to 28 min, and 0.0 V (completely reduced state) from 28 to 64 min, and 0.8 V (completely oxidized state) from 64 to 100 min. The gray dash line shows the prediction from the batch system mass balance equations using the kₐₚₚ^{0.8 V} and kₐₚₚ^{0.0 V} values.

FIG. 8 has seven panels (a-g). Panel b depicts the C_{MVK}−t relationships in a batch reactor when two different potential-time profiles (shown in panel a and panel c) were applied. The circles or squares in panel b are experimentally determined concentrations. The shaded bands are the predictions from the batch system mass balance relationship using the kₐₚₚ^{0.8 V}, kₐₚₚ^{0.6 V}, kₐₚₚ^{0.4 V}, kₐₚₚ^{0.2 V}, and kₐₚₚ^{0.0 V} values. Panel d depicts a plot of the first derivative (dC_{MVK}/dt) of the upper line shown in panel b. Panel e depicts a plot of the second derivative (d²C_{MVK}/dt²) of the upper line shown in panel b. Panel f depicts a plot of the first derivative (dC_{MVK}/dt) of the lower line shown in panel b. Panel g depicts a plot of the second derivative (d²C_{MVK}/dt²) of the lower line shown in panel b.

FIG. 9 has four panels (a-d). Panel a depicts schematics of the ERHC-integrated flow reactor employed in the COMSOL simulation. Panel b depicts a plot of C_{Z} as a function of the axial position within the reactor when a series of different potentials were applied to all of the catalyst sheets. Panel c depicts a plot of the applied potential (bars, right axis) and the corresponding C_{Z} (line, left axis) as a function of position in the z-direction. Panel d depicts a plot of the applied potential (line, right axis) and the corresponding concentration Cₒᵤₜₗₑₜ (circles, left axis) as a function of time.

FIG. 10 has six panels (a-f). Panel a depicts kₐₚₚ values obtained at three different electrochemical potentials using the PVF/CF hybrids as the catalysts for the Michael addition reaction between methyl vinyl ketone and 2-acetylcyclopentanone. Panel b depicts kₐₚₚ values obtained at three different electrochemical potentials using the PVF/CF hybrids as the catalysts for the Michael addition reaction between methyl vinyl ketone and ethyl acetoacetate. Panel c depicts kₐₚₚ values obtained at three different electrochemical potentials using the PVF/CF hybrids as the catalysts for the Michael addition reaction between methyl vinyl ketone and ethyl 2-ethylacetoacetate. Panel d depicts kₐₚₚ values obtained at three different electrochemical potentials using the PVF/CF hybrids as the catalysts for the Michael addition reaction between trans-4-phenyl-3-buten-2-one and ethyl 2-oxo-cyclopentane carboxylate. Panel e depicts kₐₚₚ values obtained at three different electrochemical potentials using the PVF/CF hybrids as the catalysts for the Michael addition reaction between trans-4-phenyl-3-buten-2-one and ethyl acetoacetate. Panel f depicts kₐₚₚ values obtained at three different electrochemical potentials using the PVF/CF hybrids as the catalysts for the Michael addition reaction between trans-4-phenyl-3-buten-2-one and ethyl acetoacetate.

FIG. 11 depicts a plot of the logarithm of the MVK concentration as a function of time when a potential of 0.8 V versus Ag/AgCl was applied to a bare CF matrix.

FIG. 12 depicts a plot showing the chronoamperometric profile of a PVF/CF catalyst with 10 min deposition when a potential of 0.6 V versus Ag/AgCl was applied to the catalyst at time zero, showing that the current decayed very quickly and thus the PVF layer could be oxidized within 5 s. Other potentials were also tested and we observed similar time scales ˜5 s.

FIG. 13 has three panels (a-c). Panel a depicts a schematic representation of the electrochemical deposition of PVF. Panel b depicts a schematic representation of the polymerization of pyrrole (Pyr). Panel c depicts a schematic representation of the simultaneous codeposition of PVF and Pyr on carbon fiber substrate.

FIG. 14 depicts UV-vis spectra of ferrocene in ethanol with various concentrations of pyrrole.

FIG. 15 has eight panels (a-h). Panel a depicts an SEM image of pristine carbon fiber (CF). Panel b depicts an SEM image of electrochemically deposited polypyrrole (PPy). Panel c depicts an SEM image of electrochemically deposited PVF on CF. Panel d and panel e depict SEM images of coreshell structured film with PPy as inner layer and PVF as outer layer on CF. Panel f, panel g, and panel h depict SEM images of PVF/PPy codeposited on CF.

FIG. 16 has three panels (a-c). Panel a depicts a TEM image of electrochemically deposited PPy. The scale bars shown are 5 nm. Panel b depicts a TEM image of electrochemically deposited PVF. The scale bars shown are 5 nm. Panel c depicts a TEM image of a PPy/PVF hybrid polymer film. The scale bars shown are 5 nm.

FIG. 17 has three panels (a-c). Panel a depicts survey scans of a control and a codeposited polymer sample. Panel b depicts a high resolution scan of N1 s of the codeposited polymer sample. Panel c depicts a high resolution scan of Fe2p of the codeposited polymer sample.

FIG. 18 has two panels (a and b). Panel a depicts the Fe2p/N1s ratio for the codeposited polymer sample. Panel b depicts the Fe2p/N1s ratio for the coreshell structured sample, CF-PPyPVF.

FIG. 19 has three panels (a-c). Panel a depicts cyclic voltammetry profiles for PPy and PVF in comparison to pristine carbon fiber. Panel b and panel c depict cyclic voltammetry profiles for polymer hybrids of various architectures.

FIG. 20 has two panels (a and b). Panel a depicts the specific capacitance of various samples calculated at scan rate of 0-0.2 V/s. Panel b depicts the galvanostatic discharge curve for various polymer-modified electrodes.

FIG. 21 has two panels (a and b). Panel a depicts a plot of intensity versus Q for SANS data obtained for PVF with and without pyrrole in solution. Panel b depicts plots of log [(intensity)-B] versus log (Q) for SANS data obtained for PVF with and without pyrrole in solution, respectively.

FIG. 22 has two panels (a and b). Panel a depicts nitrogen adsorption-desorption isotherms of the PVF/PPy polymer hybrid. Panel b depicts the corresponding BJH pore-size distribution for the polymer hybrid.

FIG. 23 has six panels (a-f) depicting the electrochemical evaluation of the two-electrode configuration. Panel a shows CV profiles for PPy, PVF and the co-deposited hybrid. Panel b shows CV profiles for the co-deposited hybrid at scan rates from 10 to 45 mV s⁻¹. Panel c shows the calculated specific capacitance at scan rates from 0.001 to 0.2 V s⁻¹. Panel d shows the galvanostatic discharge curves recorded at 0.7 A g⁻¹ and the calculated specific capacitance. Panel e shows the galvanostatic discharge curves of the co-deposited PVF/PPy hybrid at current densities from 0.7 to 10 A g⁻¹. Panel f shows the calculated specific capacitance of PVF, PPy, and the co-deposited hybrid at current densities from 0.06 to 10 A g⁻¹.

FIG. 24 has two panels (a and b). Panel a shows Nyquist plots for CF-PVF, CF-PPy, and CF-Codep indicating lower solution and interfacial charge transfer resistances for the co-deposited polymer hybrids. Panel b shows the Ragone plot for the PVF/PPy polymer hybrid-based two-electrode symmetric supercapacitor performance relative to that of other conducing polymer-based supercapacitors reported in [48] W. C. Jiang, et al., Adv. Funct. Mater. 2015, 25, 1063; [51] Y. J. Peng, et al., J. Power Sources 2014, 272, 970; [52] W. K. Chee, et al., Electrochim. Acta 2015, 157, 88; [53] Y. L. Zhu, et al., J. Power Sources 2014, 268, 233; [54] P. X. Li, et al., ACS Appl. Mater. Interfaces 2014, 6, 5228; [55] H. X. Feng, et al., J. Power Sources 2014, 246, 621; [56] G. F. Chen, et al., Chem. Eur. J. 2015, 21, 4614; [57] X. Y. Cai, et al., J. Power Sources 2015, 275, 298; [58] M. Shao, et al., Small 2015, 1613; [59] W. C. Chuan Xia, et al., Adv. Energy Mater. 2015, 5, 1614.

FIG. 25 has two panels (a and b). Panel a shows the PVF/PPy hybrid electrode exhibited a more distorted CV profile after the hydrothermal process compared to that of the untreated electrode. Panel b shows the cycling stability of the PVF/PPy hybrid modified electrode was significantly improved following the hydrothermal treatment, with retention of 94.5% of its specific capacitance at 5 A g⁻¹ after 3000 cycles.

FIG. 26 has three panels (a-c). Panel a shows SANS profiles of PVF with and without pyrrole, indicating the conformation change of PVF chains in solution. Inset: Partial Zimm plots of PVF and PVF in the presence of pyrrole. Panel b depicts the UV-vis absorbance of 0.3 mM ferrocene in ethanol, which decreases significantly as the concentration of pyrrole increases from 0 to 100 mM. Panel c depicts FTIR of PVF, PPy and the formed hybrid, which indicate the red-shift of peaks for C═C stretching and C—N stretching in the pyrrole ring and the C—H stretching in the ferrocene moieties.

### DETAILED DESCRIPTION

### Overview

Electrochemically Responsive Heterogeneous Catalysis

In certain embodiments, the invention relates to compositions and methods useful for manipulating reaction kinetics through electrochemically responsive heterogeneous catalysis (ERHC). In certain embodiments, the invention relates to a composition comprising (i) an electron-conducting framework (e.g., interconnected conductive fibers) and (ii) a conformally coated redox-switchable catalyst (e.g., PVF) whose activities can vary markedly with changes in redox states. In certain embodiments, the invention relates to a method of using any of the compositions described herein in an easily controlled ERHC reaction.

In certain embodiments, the invention relates to any of the compositions described herein, wherein the physical, chemical, or electrochemical properties of the composition, such as the surface functionalization efficiency, may be controlled by varying the potentiostatic deposition time of the coating. This fabrication approach is very versatile; in certain embodiments, other functional components, such as aniline, pyrrole, carbon nanotubes and graphene oxides, could be electrochemically co-deposited with PVF to improve the catalysis performance.

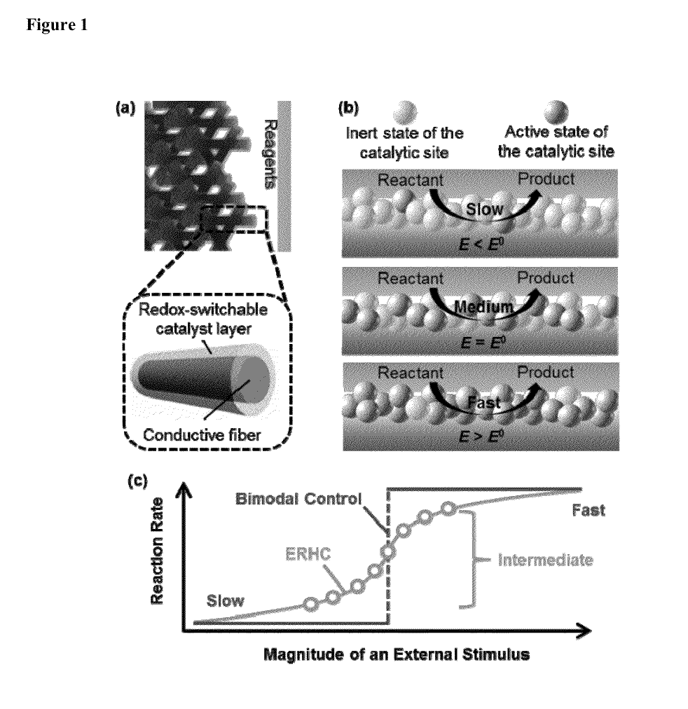

In certain embodiments, the invention relates to the use of any of the compositions described herein as a heterogeneous catalyst in a chemical reaction. In certain embodiments, the invention relates to any of the catalytic methods described herein, wherein the reaction rate may be varied continuously by the application of different electrochemical potentials. As an example, FIG. 1, panel b illustrates a simple, exemplary case whereby the catalytic site is activated when oxidized, and deactivated when reduced. When the applied potential (E) on the conductive framework is much lower than the formal potential (E⁰) of the redox-switchable catalyst, most catalytic sites are deactivated and thus the reaction is slow. When E>>E⁰, most catalytic sites are activated and thus the reaction is fast. In “on/off” bimodal catalysis (e.g., several responsive gel-based catalysts), variations of external signals usually make reactions either fast or slow (FIG. 1, panel c, line). In contrast, in an ERHC system, the electrochemical potential can be employed to modulate the reaction rate continuously and thus achieve intermediate rates (FIG. 1, panel c, circles). Such flexible control over reaction rates is highly desirable in chemical synthesis, especially for mechanistic studies of reaction kinetics, selectivity control in complex reaction networks, and safe heat removal in exothermic reactions.

In certain embodiments, the invention relates to any of the catalytic methods described herein, wherein the electrochemical potential can be varied locally in real-time with high resolution, allowing for precise spatial and temporal control of the catalyst's activity. Such precise control would benefit reaction engineering tremendously, a main objective of which is to adjust reactant distributions in reactors as functions of both location and time.

In certain embodiments, the invention relates to a fixed-bed flow reactor comprising any of the compositions described herein. Unlike soft materials-based catalysts, activation/deactivation of the ERHC system does not lead to significant changes in volume. Therefore ERHC meets a major goal of modern chemistry, that is, to combine the advantages of heterogeneous catalysis and flow chemistry to enhance the sustainability of chemical synthesis practices. However, many of the soft materials-based catalysts undergo significant morphological/structural changes (e.g., volumetric and sol-gel transitions) during the activation/deactivation process, and hence these systems cannot be used easily in a fixed bed reactor that requires a fixed catalyst volume and no catalyst leaching.

Energy Storage

In certain embodiments, the invention relates to compositions and methods useful for charge storage applications.

In certain embodiments, the invention relates to a composition comprising (i) an electron-conducting framework (e.g., interconnected conductive fibers) and (ii) a conformally coated nanoporous electrochemically active film. In certain embodiments, the nanoporous film comprises a non-conducting polymer (such as polyvinylferrocene) in a conductive polypyrrole network. By exploiting the molecular interaction between the conducting polymer and PVF, long range order is achieved, resulting in superior electrochemical performance. While not wishing to be bound by any particular theory, the conducing polymer and the PVF in the highly porous film work synergistically to provide unexpected properties, such as charge storage capability. The chemical and physical interaction of the PVF and the conducting polymer facilitates counter-ion diffusion, thereby increasing the utilization efficiency of PVF.

In certain embodiments, the invention relates to making the compositions described herein without the use of a surfactant or an additional sonication step to disperse the electron-conducting framework (e.g., the graphite powders or carbon nanotubes) prior to coating. This allows the fabrication process to be achieved in a single step, and to be readily scalable.

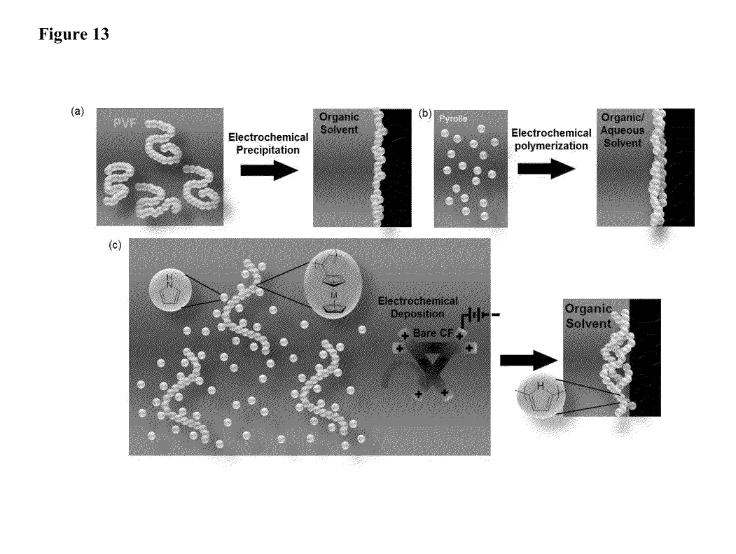

In certain embodiments, the invention relates to a one-step strategy for preparing any of the compositions described herein. For example, in certain embodiments, the preparation involves the simultaneous electrochemical polymerization of pyrrole and the electrochemical precipitation of PVF molecules on a carbon fiber matrix (FIG. 13), thereby forming an interpenetrating network.

### DEFINITIONS

For convenience, before further description of the present invention, certain terms employed in the specification, examples and appended claims are collected here. These definitions should be read in light of the remainder of the disclosure and understood as by a person of skill in the art. Unless defined otherwise, all technical and scientific terms used herein have the same meaning as commonly understood by a person of ordinary skill in the art.

The articles “a” and “an” are used herein to refer to one or to more than one (i.e., to at least one) of the grammatical object of the article. By way of example, “an element” means one element or more than one element.

The term “associated with” as used herein refers to the presence of either weak or strong or both interactions between molecules. For example weak interactions may include, for example, electrostatic, van der Waals, or hydrogen-bonding interactions. Stronger interactions, also referred to as being chemically bonded, refer to, for example, covalent, ionic, or coordinative bonds between two molecules. The term “associated with” also refers to a compound that may be physically intertwined within the foldings of another molecule, even when none of the above types of bonds are present. For example, an inorganic compound may be considered as being in association with a polymer by virtue of it existing within the interstices of the polymer.

The terms “comprise” and “comprising” are used in the inclusive, open sense, meaning that additional elements may be included.

The term “including” is used to mean “including but not limited to”. “Including” and “including but not limited to” are used interchangeably.

The term “polymer” is used to mean a large molecule formed by the union of repeating units (monomers). The term polymer also encompasses copolymers.

### Exemplary Composite Materials

One aspect of the invention relates to a composite material comprising, consisting essentially of, or consisting of: a conductive matrix; and an electrochemically active polymer.

In certain embodiments, the invention relates to any one of the composite materials described herein, wherein the conductive matrix comprises a fiber. In certain embodiments, the invention relates to any one of the composite materials described herein, wherein the conductive matrix comprises a plurality of fibers.

In certain embodiments, the invention relates to any one of the composite materials described herein, wherein the conductive matrix comprises carbon or a metal.

In certain embodiments, the invention relates to any one of the composite materials described herein, wherein the conductive matrix is porous. In certain embodiments, the invention relates to any one of the composite materials described herein, wherein the conductive matrix is porous; and the average pore diameter is from about 1 nm to about 100 μm. In certain embodiments, the invention relates to any one of the composite materials described herein, wherein the conductive matrix is porous; and the average pore diameter is about 1 nm, about 2 nm, about 3 nm, about 5 nm, about 5 nm, about 10 nm, about 50 nm, about 100 nm, about 500 nm, about 1 μm, about 2 μm, about 3 μm, about 4 μm, about 5 μm, about 10 μm, about 50 μm, or about 100 μm.

In certain embodiments, the invention relates to any one of the composite materials described herein, wherein the conductive matrix comprises carbon fiber. For example, carbonized electrospus nanofibers having an average diameter of about 100 nm may be used as the conductive matrix. Matts of nonwoven nanofibers may be made, for example, by electrospinning a polymer solution, such as polyacrylonitrile in dimethyl fumarate, to form a nonwoven matt of polymeric nanofibers. The formed fiber matts may then underso stabilization and carbonization processes to be converted to carbon fibers with excellect conductivity and a nanoporous structure.

In certain embodiments, the invention relates to any one of the composite materials described herein, wherein the conductive matrix comprises gold, platinum, or silver.

In certain embodiments, the invention relates to any one of the composite materials described herein, wherein the conductive matrix has a nominal surface area from about 0.1 cm² to about 10 cm². In certain embodiments, the invention relates to any one of the composite materials described herein, wherein the conductive matrix has a nominal surface area of about 0.1 cm², about 0.2 cm², about 0.3 cm², about 0.4 cm², about 0.5 cm², about 0.6 cm², about 0.7 cm², about 0.8 cm², about 0.9 cm², about 1 cm², about 2 cm², about 3 cm², about 4 cm², about 5 cm², about 6 cm², about 7 cm², about 8 cm², about 9 cm², or about 10 cm².

In certain embodiments, the invention relates to any one of the composite materials described herein, wherein the thickness of the conductive matrix is from about 20 μm to about 500 μm. In certain embodiments, the invention relates to any one of the composite materials described herein, wherein the thickness of the conductive matrix is about 20 μm, about 40 μm, about 60 μm, about 80 μm, about 100 μm, about 150 μm, about 200 μm, about 250 μm, about 300 μm, about 350 μm, about 400 μm, about 450 μm, or about 500 μm.

In certain embodiments, the invention relates to any one of the composite materials described herein, wherein the conductive matrix comprises a plurality of fibers; and the diameter of each fiber is from about 0.2 μm to about 2 μm. In certain embodiments, the invention relates to any one of the composite materials described herein, wherein the conductive matrix comprises a plurality of fibers; and the diameter of each fiber is about 0.2 μm, about 0.3 μm, about 0.4 μm, about 0.5 μm, about 0.6 μm, about 0.7 μm, about 0.8 μm, about 0.9 μm, about 1.0 μm, about 1.1 μm, about 1.2 μm, about 1.3 μm, about 1.4 μm, about 1.5 μm, about 1.6 μm, about 1.7 μm, about 1.8 μm, about 1.9 μm, or about 2 μm.

In certain embodiments, the invention relates to any one of the composite materials described herein, wherein the conductive matrix comprises a plurality of fibers in the form of a nonwoven network.

In certain embodiments, the invention relates to any one of the composite materials described herein, wherein the conductive matrix is in the form of a tube.

In certain embodiments, the invention relates to any one of the composite materials described herein, wherein the conductive matrix is in the form of a porous solid matrix, such as a metal sponge or metal foam.

In certain embodiments, the invention relates to any one of the composite materials described herein, wherein the conductive matrix has a conductivity from about 0.1 S/cm to about 10000 S/cm. In certain embodiments, the invention relates to any one of the composite materials described herein, wherein the conductive matrix has a conductivity of about 0.1 S/cm, about 0.2 S/cm, about 0.3 S/cm, about 0.4 S/cm, about 0.5 S/cm, about 1 S/cm, about 5 s/cm, about 10 S/cm, about 50 S/cm, about 100 S/cm, about 500 S/cm, about 1000 S/cm, about 5000 S/cm, or about 10000 S/cm.

In certain embodiments, the invention relates to any one of the composite materials described herein, wherein the electrochemically active polymer is a conducting polymer. Conducting polymers useful in the composite materials of the invention have conjugated backbones. In the case of conducting polymers, the motion of delocalized electrons occurs through conjugated systems; however, the electron hopping mechanism is likely to be operative, especially between chains (interchain conduction) and defects. Electrochemical transformation usually leads to a reorganization of the bonds of the polymers prepared by oxidative or less frequently reductive polymerization of benzoid or nonbenzoid (mostly amines) and heterocyclic compounds. Examples of conducting polymers include, but are not limited to, polyaniline and its derivatives (such as poly(o-toluidine), poly(o-methoxyaniline), poly(o-ethoxyaniline), poly(1-pyreneamine), poly(4-aminobenzoic acid), poly(l-aminoanthracene), poly(N-methylaniline), and poly(N-phenyl-2-naphthylamine)), poly(diphenylamine), poly(2-aminodiphenylamine), poly(o-phenylenediamine), poly(o-aminophenol), polyuminol, polypyrrole and its derivatives (such as poly(3,4-ethylenedioxypyrrole), poly(3,4-propylenedioxypyrrole), and poly(N-sulfonatopropoxy-dioxypyrrole)), polyindole and its derivatives, polymelatonin, polyindoline, polycarbazoles, polythiophene and its derivatives (such as poly(3,4-ethylenedioxythiophene)), polyphenazine, poly(p-phenylene), and poly(phenylenevinylene).

In certain embodiments, the invention relates to any one of the composite materials described herein, wherein the electrochemically active polymer is a redox polymer. Redox polymers contain electrostatically and spatially localized redox sites that can be oxidized or reduced, and the electrons are transported by an electron exchange reaction (electron hopping) between neighboring redox sites if the segmental motions enable this. Redox polymers can be divided into several subclasses: (1) Polymers that contain covalently attached redox sites, either built into the chain, or as pendant groups; the redox centers are mostly organic or organometallic molecules; and (2) Ion exchange polymeric systems (polyelectrolytes) where the redox active ions (mostly complex compounds) are held by electrostatic binding. Examples of redox polymers include, but are not limited to, poly(tetrathiafulvalene), quinoline polymers, poly(vinylferrocene), and [Ru(2,2′-bipyridyl)2-(4-vinylpyridine)₅Cl]Cl.

In certain embodiments, the invention relates to any one of the composite materials described herein, wherein the electrochemically active polymer comprises a conducting polymer and a redox polymer.

In certain embodiments, the invention relates to any one of the composite materials described herein, wherein the electrochemically active polymer has a molecular weight from about 10,000 g/mol to about 500,000 g/mol. In certain embodiments, the invention relates to any one of the composite materials described herein, wherein the electrochemically active polymer has a molecular weight of about 10,000 g/mol, about 20,000 g/mol, about 30,000 g/mol, about 40,000 g/mol, about 50,000 g/mol, about 60,000 g/mol, about 70,000 g/mol, about 80,000 g/mol, about 90,000 g/mol, about 100,000 g/mol, about 150,000 g/mol, about 200,000 g/mol, about 250,000 g/mol, about 300,000 g/mol, about 350,000 g/mol, about 400,000 g/mol, about 450,000 g/mol, or about 500,000 g/mol.

In certain embodiments, the invention relates to any one of the composite materials described herein, wherein the composite material has a specific capacitance from about 10 F/g to about 800 F/g. In certain embodiments, the invention relates to any one of the composite materials described herein, wherein the composite material has a specific capacitance of about 20 F/g, about 30 F/g, about 40 F/g, about 50 F/g, about 60 F/g, about 70 F/g, about 80 F/g, about 90 F/g, about 100 F/g, about 150 F/g, about 200 F/g, about 250 F/g, about 300 F/g, about 350 F/g, about 400 F/g, about 450 F/g, about 500 F/g, about 550 F/g, about 600 F/g, about 650 F/g, about 700 F/g, about 750 F/g, or about 800 F/g.

In certain embodiments, the invention relates to any one of the composite materials described herein, wherein the electrochemically active polymer comprises a redox polymer; and the redox polymer is polyvinylferrocene.

In certain embodiments, the invention relates to any one of the composite materials described herein, wherein the polyvinylferrocene has a molecular weight from about 10,000 g/mol to about 500,000 g/mol. In certain embodiments, the invention relates to any one of the composite materials described herein, wherein the polyvinylferrocene has a molecular weight of about 10,000 g/mol, about 20,000 g/mol, about 30,000 g/mol, about 40,000 g/mol, about 50,000 g/mol, about 60,000 g/mol, about 70,000 g/mol, about 80,000 g/mol, about 90,000 g/mol, about 100,000 g/mol, about 150,000 g/mol, about 200,000 g/mol, about 250,000 g/mol, about 300,000 g/mol, about 350,000 g/mol, about 400,000 g/mol, about 450,000 g/mol, or about 500,000 g/mol.

In certain embodiments, the invention relates to any one of the composite materials described herein, wherein the electrochemically active polymer comprises a redox polymer; and the composite material has a specific capacitance from about 10 F/g to about 50 F/g. In certain embodiments, the invention relates to any one of the composite materials described herein, wherein the electrochemically active polymer comprises a redox polymer; and the composite material has a specific capacitance of about 10 F/g, about 20 F/g, about 30 F/g, about 40 F/g, or about 50 F/g.

In certain embodiments, the invention relates to any one of the composite materials described herein, wherein the electrochemically active polymer comprises a conducting polymer.

In certain embodiments, the invention relates to any one of the composite materials described herein, wherein the electrochemically active polymer comprises a conducting polymer; and the composite material has a specific capacitance from about 40 F/g to about 120 F/g. In certain embodiments, the invention relates to any one of the composite materials described herein, wherein the electrochemically active polymer comprises a conducting polymer; and the composite material has a specific capacitance of about 40 F/g, about 50 F/g, about 60 F/g, about 70 F/g, about 80 F/g, about 90 F/g, about 100 F/g, about 110 F/g, or about 120 F/g.

In certain embodiments, the invention relates to any one of the composite materials described herein, wherein the electrochemically active polymer comprises a conducting polymer and a redox polymer.

In certain embodiments, the invention relates to any one of the composite materials described herein, wherein the electrochemically active polymer comprises a conducting polymer and a redox polymer; and the composite material has a specific capacitance from about 200 F/g to about 800 F/g. In certain embodiments, the invention relates to any one of the composite materials described herein, wherein the electrochemically active polymer comprises a conducting polymer and a redox polymer; and the composite material has a specific capacitance of about 200 F/g, about 250 F/g, about 300 F/g, about 350 F/g, about 400 F/g, about 450 F/g, about 500 F/g, about 550 F/g, about 600 F/g, about 650 F/g, about 700 F/g, about 750 F/g, or about 800 F/g.

In certain embodiments, the invention relates to any one of the composite materials described herein, wherein the electrochemically active polymer comprises a conducting polymer; and the conducting polymer is polypyrrole. In certain embodiments, the invention relates to any one of the composite materials described herein, wherein the electrochemically active polymer comprises a conducting polymer and a redox polymer; and the conducting polymer is polypyrrole.

In certain embodiments, the invention relates to any one of the composite materials described herein, wherein the polypyrrole has a molecular weight from about 25,000 g/mol to about 1,000,000 g/mol. In certain embodiments, the invention relates to any one of the composite materials described herein, wherein the polypyrrole has a molecular weight of about 25,000 g/mol, about 30,000 g/mol, about 35,000 g/mol, about 40,000 g/mol, about 45,000 g/mol, about 50,000 g/mol, about 100,000 g/mol, about 200,000 g/mol, about 300,000 g/mol, about 400,000 g/mol, about 500,000 g/mol, about 600,000 g/mol, about 700,000 g/mol, about 800,000 g/mol, about 900,000 g/mol, or about 1,000,000 g/mol.

In certain embodiments, the invention relates to any one of the composite materials described herein, wherein the conductive matrix is conformally coated with the electrochemically active polymer.

In certain embodiments, the invention relates to any one of the composite materials described herein, wherein the electrochemically active polymer is a film.

In certain embodiments, the invention relates to any one of the composite materials described herein, wherein the electrochemically active polymer is a film having a thickness from about 5 nm to about 200 nm. In certain embodiments, the invention relates to any one of the composite materials described herein, wherein the electrochemically active polymer is a film having a thickness of about 5 nm, about 10 nm, about 15 nm, about 20 nm, about 25 nm, about 30 nm, about 35 nm, about 40 nm, about 45 nm, about 50 nm, about 55 nm, about 60 nm, about 65 nm, about 70 nm, about 75 nm, about 80 nm, about 85 nm, about 90 nm, about 95 nm, about 100 nm, about 110 nm, about 120 nm, about 130 nm, about 140 nm, about 150 nm, about 160 nm, about 170 nm, about 180 nm, about 190 nm, or about 200 nm. In certain embodiments, the thickness of the polymer film may be manipulated or controlled by varying deposition time.

In certain embodiments, the invention relates to any one of the composite materials described herein, wherein the electrochemically active polymer is a film; the conductive matrix is conformally coated with the electrochemically active polymer film; the electrochemically active polymer comprises a redox polymer; the redox polymer is polyvinylferrocene; and the density of ferrocene moieties on the conductive matrix is from about 0.2 nmol/cm² to about 1.8 nmol/cm². In certain embodiments, the density of ferrocene moieties on the conductive matrix is about 0.5 nmol/cm², about 0.6 nmol/cm², about 0.7 nmol/cm², about 0.8 nmol/cm², about 0.9 nmol/cm², about 1.0 nmol/cm², about 1.1 nmol/cm², about 1.2 nmol/cm², or about 1.3 nmol/cm².

In certain embodiments, the invention relates to any one of the composite materials described herein, wherein the electrochemically active polymer is nanoporous. In certain embodiments, the invention relates to any one of the composite materials described herein, wherein the electrochemically active polymer comprises a conducting polymer and a redox polymer; and the electrochemically active polymer is nanoporous. In certain embodiments, the average pore diameter of the nanoporous electrochemically active polymer is from about 25 nm to about 300 nm. In certain embodiments, the average pore diameter of the nanoporous electrochemically active polymer is about 25 nm, about 30 nm, about 35 nm, about 40 nm, about 45 nm, about 50 nm, about 60 nm, about 70 nm, about 80 nm, about 90 nm, about 100 nm, about 150 nm, about 200 nm, about 250 nm, or about 300 nm. In certain embodiments, the average pore diameter is estimated by high resolution transmission electron microscopy.

In certain embodiments, the invention relates to any one of the composite materials described herein, wherein the electrochemically active polymer comprises a conducting polymer and a redox polymer; the conducting polymer and the redox polymer are in the form of clusters; and the electrochemically active polymer is nanoporous. In certain embodiments, the clusters are substantially spherical. In certain embodiments, the clusters have an average diameter from about 25 nm to about 150 nm. In certain embodiments, the clusters have an average diameter of about 25 nm, about 50 nm, about 75 nm, about 100 nm, about 125 nm, or about 150 nm. In certain embodiments, the average diameter of the clusters is estimated by high resolution scanning electron microscopy.

In certain embodiments, the invention relates to any one of the composite materials described herein, further comprising silica, carbon black, carbon nanotubes, graphene, graphene oxide, or metal. In certain embodiments, the invention relates to any one of the composite materials described herein, further comprising a plurality of nanoparticles comprising silica, carbon black, carbon nanotubes, graphene, graphene oxide, or metal.

### Exemplary Devices

In certain embodiments, the invention relates to a fixed-bed flow reactor comprising any of the composite materials described herein.

In certain embodiments, the invention relates to a charge storage device comprising any of the composite materials described herein.

In certain embodiments, the invention relates to any of the charge storage devices described herein, wherein the charge storage device is a supercapacitor.

In certain embodiments, the invention relates to a separation medium comprising any of the composite materials described herein.

In certain embodiments, the invention relates to a sensor or a detector comprising any of the composite materials described herein.

### Exemplary Methods of Use

In certain embodiments, the invention relates to a method of catalyzing a chemical transformation of a starting material (or a first starting material and a second starting material) to a product, comprising the steps of:
contacting in an electrochemical cell the starting material (or the first starting material and the second starting material) with any of the composite materials described herein, thereby forming a reaction mixture;
applying to the reaction mixture an electrochemical potential, thereby forming a quantity of the product; and
after a period of time, removing the electrochemical potential.

In certain embodiments, the invention relates to any one of the methods described herein, wherein the method is a method of heterogeneous catalysis.

In certain embodiments, the invention relates to any one of the methods described herein, wherein the chemical transformation is a conjugate addition reaction (i.e., a 1,4-addition reaction).

In certain embodiments, the invention relates to any one of the methods described herein, wherein the first starting material comprises a conjugated carbonyl. In certain embodiments, the invention relates to any one of the methods described herein, wherein the first starting material is an alkyl vinyl ketone. In certain embodiments, the invention relates to any one of the methods described herein, wherein the first starting material is methyl vinyl ketone.

In certain embodiments, the invention relates to any one of the methods described herein, wherein the second starting material comprises a nucleophile.

In certain embodiments, the invention relates to any one of the methods described herein, wherein the second starting material is a β-ketoester, an enolate, an enamine, an alcohol, ⁻OH, a thiol, a primary amine, a secondary amine, a halide, hydrogen cyanide, ⁻CN, a boronic acid, a boronic ester, or a heteroaromatic compound.

In certain embodiments, the invention relates to any one of the methods described herein, wherein the second starting material is a β-ketoester, or an enolate thereof. In certain embodiments, the invention relates to any one of the methods described herein, wherein the second starting material is a cyclic β-ketoester, or an enolate thereof.

In certain embodiments, the invention relates to a method, comprising the steps of:
contacting in an electrochemical cell a fluid with any of the composite materials described herein, wherein the fluid comprises a plurality of ionic moieties, thereby forming a mixture; and
applying to the mixture an electrochemical potential, thereby adsorbing a quantity of the ionic moieties onto the composite material.

In certain embodiments, the invention relates to a method of sensing or detecting the presence of or the concentration of an analyte in a fluid, comprising the steps of:
contacting in an electrochemical cell the fluid with any of the composite materials described herein, wherein the fluid comprises a first quantity of an analyte, thereby forming a mixture; and
applying to the mixture an electrochemical potential, thereby adsorbing a second quantity of analyte onto the composite material.

In certain embodiments, the invention relates to any one of the methods described herein, wherein the analyte is an ionic moiety.

In certain embodiments, the invention relates to any one of the methods described herein, wherein the fluid is a liquid or a gas.

In certain embodiments, the invention relates to any one of the methods described herein, wherein the electrochemical potential is from about 0.05 V to about 1.0 V. In certain embodiments, the invention relates to any one of the methods described herein, wherein the electrochemical potential is about 0.1 V, about 0.2 V, about 0.3 V, about 0.4 V, about 0.5 V, about 0.6 V, about 0.7 V, about 0.8 V, or about 0.9 V.

In certain embodiments, the invention relates to any one of the methods described herein, wherein the electrochemical cell further comprises an electrolyte solution.

### Exemplary Methods of Preparation

In certain embodiments, the invention relates to a method comprising the steps of:

contacting in an electrochemical cell a conductive matrix with (i) an electrochemically active polymer, (ii) an electro-polymerizable monomer that, once polymerized, forms an electrochemically active polymer, or (iii) both (i) and (ii), thereby forming a deposition mixture; and

applying to the deposition mixture an electrochemical potential, thereby (i) depositing onto the conductive matrix the electrochemically active polymer, (ii) depositing onto the conductive matrix an electrochemically active polymer derived from the electro-polymerizable monomer, or (iii) depositing onto the conductive matrix a hybrid polymer.

In certain embodiments, the invention relates to any one of the methods described herein, wherein the electrochemical cell further comprises an electrolyte solution.

### EXEMPLIFICATION

The invention now being generally described, it will be more readily understood by reference to the following examples, which are included merely for purposes of illustration of certain aspects and embodiments of the present invention, and are not intended to limit the invention.

### Example 1

### Electrochemically Responsive Heterogeneous Catalysis for Controlling Reaction Kinetics

Chemicals and Materials.

Polyvinylferrocene (molecular weight=50,000 g/mol) was obtained from Polysciences. Methyl vinyl ketone, ethyl-2-oxycyclopentane carboxylate, 2-acetylcyclopentanone, ethyl acetoacetate, ethyl-2-ethylacetoacetate, trans-4-phenyl-3-buten-2-one, sodium perchlorate, tetrabutylammonium perchlorate, and chloroform were purchased form Sigma Aldrich. Deuterated methanol was purchased from Cambridge Isotope. All reagents were used as received throughout the study, without further purification or chemical modification unless otherwise noted. A platinum wire auxiliary electrode and an Ag/AgCl (3 M NaCl) reference electrode were purchased from BASi.

Instrumentation.

Scanning electron microscopy (JOEL-6010LA) was used to investigate the morphologies of the PVF/CF catalysts and perform energy dispersive elemental mapping. X-ray photoelectron spectra were recorded with a Kratos Axis Ultra instrument equipped with a monochromatic Al Kα source operated at 150 W. Electrochemical experiments were performed on an AutoLab PGSTAT 30 potentiostat with GPES software. ¹H-NMR analysis was performed in deuterated methanol with a Bruker 400. The nitrogen adsorption/desorption measurements were performed with ASAP2020, Micromeritics.

Fabrication of PVF/CF Hybrids.

A carbon fiber matrix (Toray, TGP-H-060) with a nominal surface area of 1 cm² and a thickness of 200 μm was immersed in 5 ml chloroform solution containing 0.1 M tetrabutylammonium perchlorate and 10 mg/ml PVF. An electrochemical potential of 0.8 V versus Ag/AgCl was applied to the carbon fiber matrix for a period of 2, 10, 20, and 30 min to induce the PVF deposition process. The surface functionalization efficiency (i.e., ferrocene surface coverage) was calculated from the cyclic voltammograms according to the following equation:

Γ=∫_{V}_{₁}^{V}^{₂}[iₐ(V)−i_{c}(V)]dV/(2AvₛeN_{A}) (1)

where Γ is the ferrocene surface coverage, V₁ and V₂ are the cutoff potentials in cyclic voltammetry, iₐ(V) and i_{c}(V) are the instantaneous anodic and cathodic currents as a function of potential, vₛ is the scan rate, e is the elementary charge, N_{A} is Avogadro's number, and A is the total surface area of the CF matrix (calculated by the mass of the CF matrix multiplied by its specific surface area, determined by nitrogen adsorption isotherms by means of the Brunauer-Emmett-Teller method). Equation (1) is a universal expression to calculate total charges; it applies to cyclic voltammograms of any shape since it uses the integral area of the cyclic voltammogram/scan rate to represent the sum of anodic and cathodic voltammetric charges.

Kinetic Measurements.

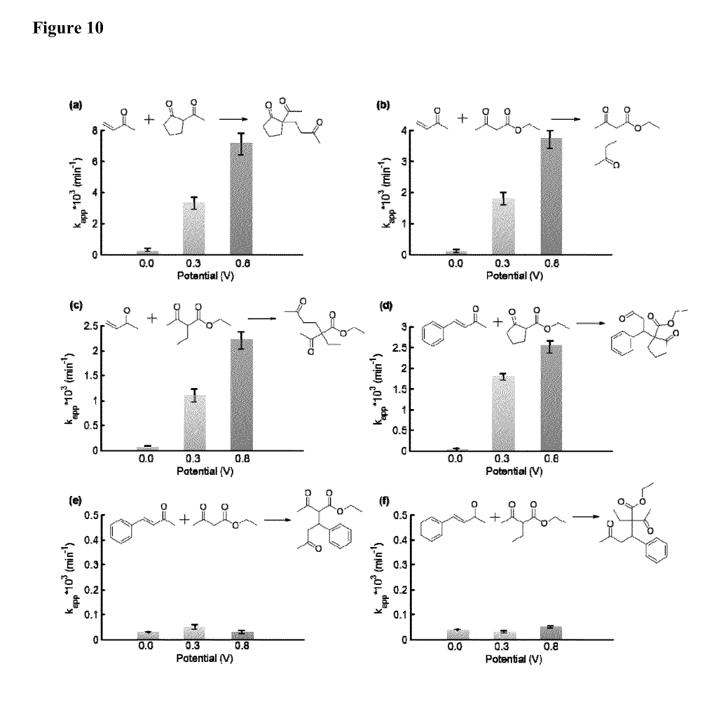

Equimolar mixtures of reactants (1 mL E2OC and 0.58 mL MVK) and the supporting electrolyte (68 mg sodium perchlorate) were added to 4 mL methanol. The reaction between E2OC and MVK was carried out in an electrochemical cell with the PVF/CF catalyst as the working electrode, a platinum wire as the counter electrode, and an Ag/AgCl electrode as the reference electrode. The reaction mixture was magnetically stirred at a speed of 220 rpm and kept at 298 K using a water bath. The progress of the reaction was followed by the time dependence of the vinyl proton NMR signal at 6.3 ppm. 0.1 mL aliquots were taken from the 4 mL reaction mixture and mixed with 0.7 mL deuterated methanol for NMR analysis. The typical sampling frequency was around 10 to 20 min. Similar procedures were adopted for other reactions shown in FIG. 10.

RPE Simulation.

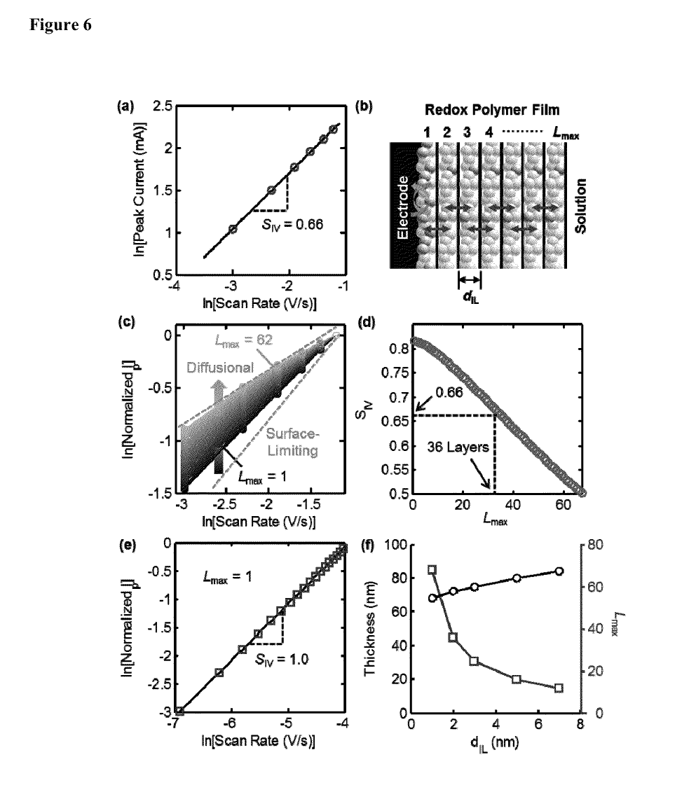

The RPE model is illustrated in FIG. 6, panel b. Numerical simulations were performed using MATLAB (2010 b). Butler-Volmer formulations were employed to describe the heterogeneous electron transfer kinetics at the electrode/polymer interface (i.e., layer 1). Fick's law of diffusion with finite difference representation was used to describe the diffusional charge transport behavior in the bulk polymer film (i.e., layer 2 through Lₘₐₓ). The electrochemical potential of the electrode was linearly increased at specified constant time intervals, and the fractional concentration of the oxidized and reduced species at each layer and the instantaneous amperometric response was recorded.

The model shown in FIG. 6, panel b in the main text is assumed. The redox polymer film is divided into Lₘₐₓ layers with an interlayer spacing of d_{IL}. Assuming that the film has a thickness of l, then d_{IL}=l/Lₘₐₓ. The electrochemical potential applied to the electrode phase is linearly varied from the starting value (Eₛ) to the final value (E_{f}) over a time span of τ with a time interval of Δt. For convenience, we assume Eₛ>E_{f}. L=τ/Δt is the number of time points required to perform a complete potential sweeping process. The scan rate, vₛ, is equal to (Eₛ−E_{f})/τ. The electron transfer process at the electrode/polymer interface (

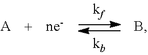

where A represents the oxidized species and B represents the reduced species, and n is the number of electrons transferred) is assumed to follow the Butler-Volmer kinetics:

k_{f}=k⁰exp[−(αnF/RT)(E−E⁰)]

k_{b}=k⁰exp[(1−α)(nF/RT)(E−E⁰)]

where k⁰ is the standard heterogeneous electron transfer rate constant, α is the transfer coefficient, F is the Faraday constant, R is the ideal gas constant, T is the absolute temperature, E is the instantaneous potential applied to the electrode, and E⁰ is the formal potential of the redox couple. Dimensionless forms of equations are used in the simulations to facilitate calculations. The dimensionless rate constant is defined as RKS=k⁰τ/L. Consequently, the dimensionless forms of k_{f} and k_{b} can be written as follows:

RKF=RKSexp[−(αnF/RT)(E−E⁰)]

RKB=RKSexp[(1−α)(nF/RT)(E−E⁰)]

The dimensionless diffusion coefficient in the bulk polymer film is defined as DM=D_{ct}Δt/(d_{IL})², where D_{ct} is the diffusional charge transfer coefficient for a redox polymer film. FCA(J, K) and FCB(J, K) represent the fractional concentrations of A and B in layer J at time point K. At layer 1, considering the direct electron exchange with the electrode and the diffusional charge transport from layer 2, the loop structures are as the following:

FCA(1,K+1)=FCA(1,K)−(RKF·FCA(1,K)−RKB·FCB(1,K))/(1+RKF/2DM+RKB/2DM)+DM[FCA(2,K)−FCA(1,K)]

FCB(1,K+1)=FCB(1,K)+(RKF·FCA(1,K)−RKB·FCB(1,K))/(1+RKF/2DM+RKB/2DM)+DM[FCB(2,K)−FCB(1,K)]

For layer 2 to Lₘₐₓ, only diffusional charge transport occurs. For layer 2 to Lₘₐₓ−1, the diffusion is from both sides of layers:

FCA(J,K+1)=FCA(J,K)+DM[FCA(J+1,K)−2FCA(J,K)+FCA(J−1,K)]

FCB(J,K+1)=FCB(J,K)+DM[FCB(J+1,K)−2FCB(J,K)+FCB(J−1,K)]

For the last layer (JMAX), the diffusion is only from the layer Lₘₐₓ−1:

FCA(JMAX,K+1)=FCA(JMAX,K)−DM[FCA(JMAX,K)−FCA(JMAX−1,K)]

FCB(JMAX,K+1)=FCB(JMAX,K)−DM[FCB(JMAX,K)−FCB(JMAX−1,K)]

In addition, it is assumed that initially the polymer is present only in its oxidized form and the potential is swept from the upper bound to the lower bound. At each time point, the FCA(J, K) and FCB(J, K) are determined. Thus for a given scan rate, the instantaneous amperometric response can be determined at each time point using the following equation:

I(K)=(RKB·FCB(1,K)−RKF·FCA(1,K))/(1+RKF/2DM+RKB/2DM)×Q\sqrt{D_{ct}vs/DM□ΔE}□d_{IL}□Lₘₐₓ

The parameters used in the simulation were: Faraday constant (F=96485.3 C/mol), ideal gas constant (R=8.314 J/mol K), the standard heterogeneous electron transfer rate constant (k⁰=1.2×10⁴ s⁻¹, derived from measurement on self-assembled ferrocene monolayers), transfer coefficient for the Butler-Volmer kinetic formulation (α=0.5 is generally assumed for PVF), charge transport diffusion coefficient for PVF films with ClO₄⁻¹ as the anion (D_{ct}=1.06×10⁻⁹ cm²/s), total charge of the redox polymer film (Q=10.7±0.2 mC, calculated from the cyclic voltammograms), formal potential of ferrocene (E⁰=0.37±0.03 V, determined from CV measurements), and the interlayer distance (we use a series values for d_{IL}: 1, 2, 3, 5, and 7 nm).

COMSOL Simulation.

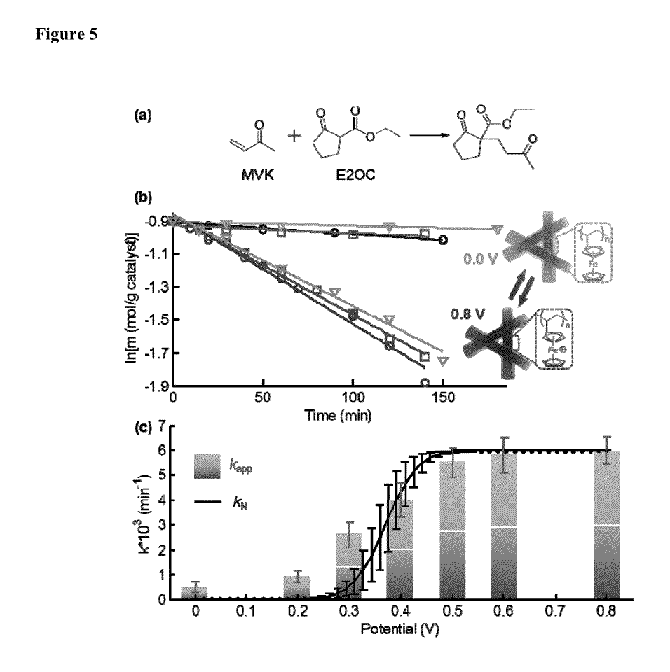

Simulations were carried out with the COMSOL (Multiphysics Version 4.2a) software package. The plug flow module was used under either transient or steady state conditions with first-order reaction kinetics for MVK. The relationship between the potential applied and the corresponding reaction rate constant was determined experimentally (see FIG. 5, panel c). The total mass of the catalyst (1,700 kg), or the size of the reactor (10 m in length and 1 m in diameter), was chosen such that when the catalyst was fully oxidized (fixed at a potential of 0.8 V), the concentration of MVK decayed to zero at the outlet. The mass of the catalyst and the volume of the reactor were correlated from the density of the PVF/CF catalyst. There were approximately 40,000 sheets in the tube reactor.

Simulations were carried out with COMSOL Multiphysics Version 4.2a. The Transport of Diluted Species module and the Plug Flow module were combined in the simulation to model the reactor under either transient or steady state conditions with first order reaction kinetics for MVK. In the Transport of Dilution Species Module, the applied boundary conditions are axial symmetry along the center line of the cylinder, no flux along the cylinder wall, constant inlet concentration at the inflow boundary, and zero concentration gradient at the outflow boundary. In the Plug Flow Module, axial symmetry is applied at the centerline. At the inlet, normal inflow velocity is applied. At the outlet, a constant pressure (atmosphere pressure) is applied as the boundary condition. For transient simulations: the initial concentration is the set as the inlet concentration. The initial velocity field is set as 0, and the pressure within the reactor is atmosphere pressure. The parameters used in the COMSOL simulation were: MVK diffusion coefficient (3×10⁻⁹ m²/s), solvent density (methanol, 786.7 kg/m³), fluid velocity (2×10⁻⁴ m/s), and solvent viscosity (5.42×10⁻⁴ Pa·s). The relationship between the potential applied and the corresponding reaction rate constant was determined experimentally. The reactor is modelled as a cylindrical reactor with a radius of 0.5 m and a height of 10 m. The mass of the catalyst and the volume of the reactor were correlated from the density of the PVF/CF catalyst. There were approximately 40,000 sheets in the tube reactor.

Scaling Analysis of the Reactant Transport Process.

To investigate if the reactant transport process affected the determination of the apparent reaction rate constant (kₐₚₚ), we estimated the reactant mass transport time scale as follows. To determine whether the system was convection- or diffusion-dominated, we calculated the Peclet number (Pe), which measures the importance of convection relative to diffusion:

$$Pe ≡ \frac{convection}{diffusion} = \frac{UL}{D}$$

where U is the flow velocity, L is the characteristic length scale for diffusion, which can be approximated as the inter-fiber distance, 10 μm, and D is the binary diffusivity of the limiting reactant in the solvent, which is on the order of 1×10⁻⁹ m²/s. The reaction mixture was stirred at 220 rpm at room temperature and the radius of the electrochemical cell (r) was 0.01 m. Hence the Pe number was estimated as follows:

$${w}_{θ} = \frac{220 rpm \times 2 π / rotation}{60 min / s} = 23.03 / s$$

$$U = {v}_{θ} = {rw}_{θ} = 0.01 m \times 23.03 / s = 0.2303 m / s$$

$$Pe = \frac{UL}{D} = \frac{0.2303 \times 10 \times {10}^{- 6}}{{10}^{- 9}} = 2.303 \times {10}^{3} •1$$

Thus the system was convection dominated. The mass transport time scale can be approximated as the convection time scale:

$${t}_{mass . transport} = {t}_{convection} = \frac{r}{U} = \frac{0.01 m}{0.2303 m / s} = 0.043 s$$

Therefore, the mass transport time scale was on the order of 0.1 s. This time scale is much shorter than the reaction time scale (1/kₐₚₚ^{0.8 V}˜167 min); hence the transport process had negligible influence on the determination of kₐₚₚ.

Fabrication and Characterization of a Model ERHC System.

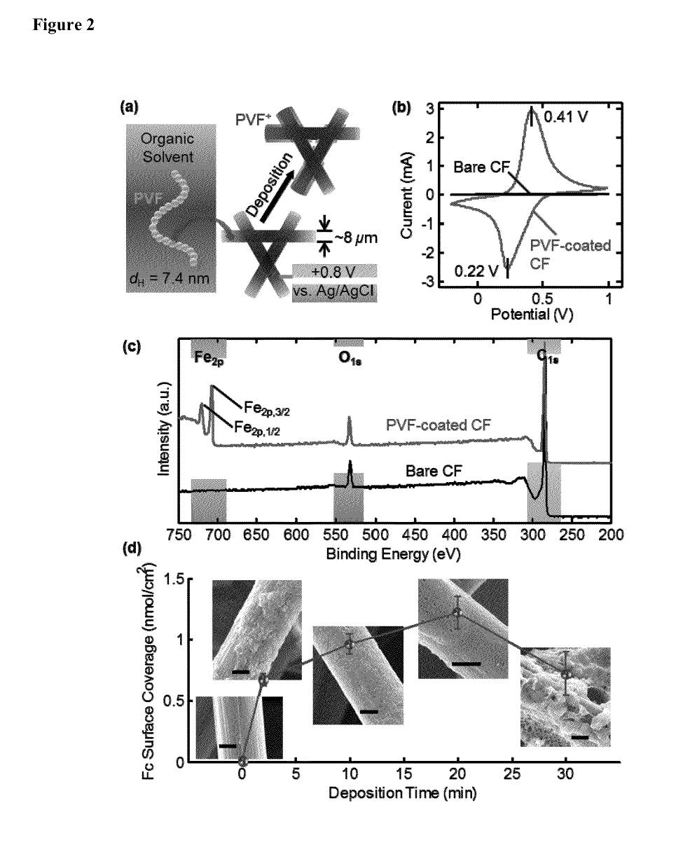

The proof-of-concept ERHC system developed here consists of a porous carbon fiber (CF) matrix with conformally coated polyvinylferrocene (PVF). Ferrocene can either function directly as a catalyst with a redox-controlled activity, or serve indirectly as a redox-active ligand to adjust the reactivity of metal complexes. The CF matrix serves as the electron-conducting framework in this ERHC system. The PVF/CF hybrid system was prepared by electrochemical oxidation-induced deposition of PVF to the CF matrix (FIG. 2, panel a). Application of a positive electrochemical potential (0.8 V) to the CF matrix provides a localized oxidative environment on the fiber surface. The affinity of ferrocene for hydrophobic organic solvents (e.g., chloroform) is reduced upon oxidation. Therefore, PVF initially soluble in chloroform becomes solvophobic and subsequently precipitates onto the fiber when it is oxidized at the fiber surface. The hydrodynamic diameter (d_{H}) of the polymer (molecular weight=50,000 g/mol) in chloroform was ˜7.4 nm. The diameter of the carbon fiber was around 8 μm.

The presence of ferrocene moieties in an as-prepared hybrid system was verified by cyclic voltammetry (CV) (FIG. 2, panel b). The PVF-coated CF matrix prepared by a 10 min potentiostatic deposition at 0.8 V showed pronounced anodic and cathodic peaks at 0.41 and 0.22 V, respectively, characteristic of ferrocene. The unmodified CF substrate showed no such signals. FIG. 2, panel c shows the wide-range X-ray photoelectron spectra (XPS) of the unmodified CFs and the PVF-coated CFs. The spectrum of PVF-coated CFs possesses a Cᵢₛ peak at 281 eV, an O_{1S} peak at 532 eV, and two Fe₂ₚ peaks at 708 eV (2p 3/2) and 721 eV (2p ½) due to the spin-orbital splitting of the iron p orbital. The spectrum of the unmodified CFs does not exhibit such Fe₂ₚ peaks. The XPS results, complementary to the CV analysis, confirm the successful surface functionalization of CFs by PVF.

The key factor to controlling the quality of the PVF coating was the potentiostatic deposition time. Scanning electron microscopy (SEM) images (FIG. 2, panel d insets) show a clear morphological transition of CFs with different deposition times. An unmodified CF exhibits a clean surface. Deposition for two minutes led to non-uniform PVF aggregates that only partially covered the fiber surface. With 10 and 20 min deposition times, conformal, uniform coating around fibers with complete surface coverage was achieved. However, a further increase in deposition time to 30 min led to uneven coating and cracking of the PVF film; we also observed that the initially deposited film fell off the CF matrix in this latter case. This poor coating quality might be due to the large thickness of the polymer film and the low solubility of PVF⁺; both factors could lead to mechanical instability of the deposited film.

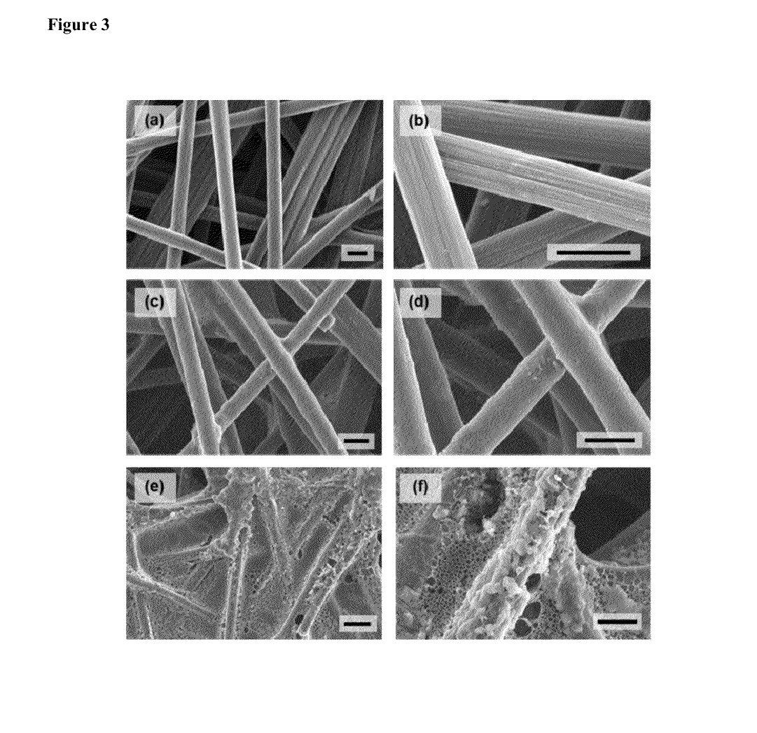

To evaluate quantitatively the deposition efficacy, we used CV measurements to estimate the ferrocene surface coverage (Γ_{Fc}, nmol/cm²) on the CFs (FIG. 2, panel d). Γ_{Fc} increased with deposition time in the range of 0-20 min, but decreased from 20 to 30 min. This later decay indicates loss of PVF, consistent with the SEM observation. Thus an intermediate deposition time (10-20 min) was thought to be optimal since it consistently generated uniform conformal PVF coatings. Large-area SEM images of unmodified CFs, and PVF-coated CFs with 10 and 30 min deposition are shown in FIG. 3.

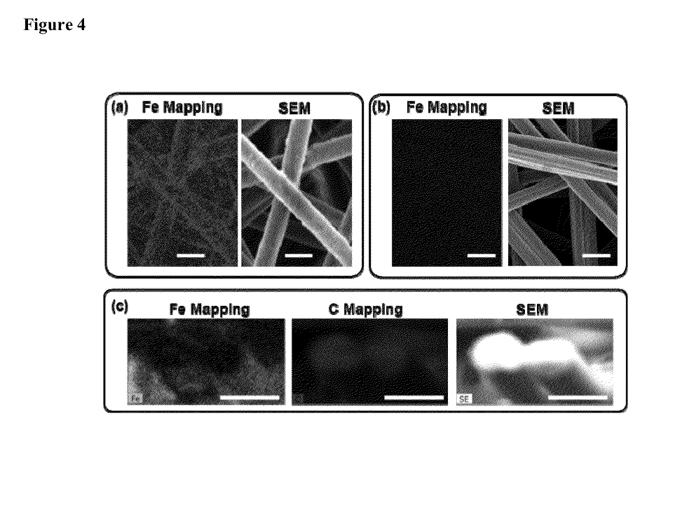

Energy dispersive X-ray spectroscopic (EDS) elemental mapping of Fe corroborated the assertion that the PVF-coated CF substrate (10 min deposition) was completely covered by the polymer (FIG. 4, panel a). In contrast, the EDS image of a bare CF substrate exhibits negligible Fe signals (FIG. 4, panel b). Additionally, the cross-sectional EDS (Fe and C) images of a cryo-fractured sample indicates a clear core (C)-shell (Fe) hybrid structure (FIG. 4, panel c).

Continuous Adjustment of Reaction Rates Using ERHC.

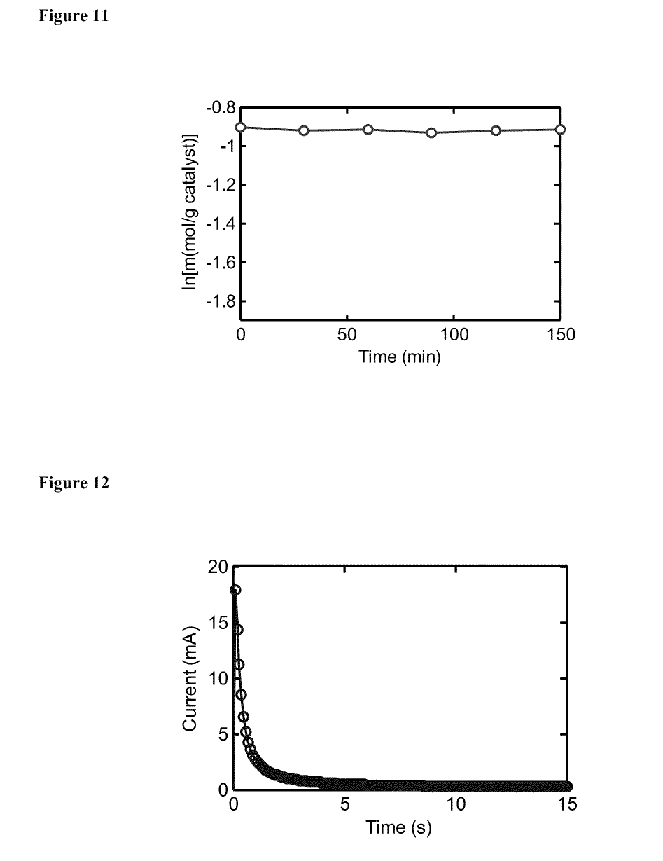

The model reaction chosen for demonstrating the use of ERHC to control kinetics is the Michael addition of methyl vinyl ketone (MVK) and ethyl-2-oxycyclopentane carboxylate (E2OC) (FIG. 5, panel a). This class of reactions is important for steroid synthesis and for forming carbon-carbon bonds in many other organic compounds. Ferrocenium (Fc⁺) catalyzes this reaction as a Lewis acid whereas ferrocene (Fc) has no catalytic activity toward this reaction. This reaction is pseudo-first order in MVK; such kinetic characteristics indicate that E2OC reacts reversibly with the catalyst to form an adduct which then reacts more slowly with MVK. For heterogeneous catalysis, it is convenient and conventional to express the reaction rate as moles of reactants reacted per unit mass of the catalyst. Thus the rate law is written as −r (mol/(g catalyst min))=−dm/dt=kₐₚₚm, where m is the concentration of MVK normalized to the catalyst mass (mol/g catalyst), and kₐₚₚ is the apparent first-order rate constant (min⁻¹). Integration of this differential equation results in: ln m=−kₐₚₚt+ln m₀, where m₀ is the initial concentration of MVK. FIG. 5, panel b shows ln m versus the reaction time, measured in the presence of a PVF/CF system prepared by 10 min potentiostatic deposition. When a potential of 0.8 V (which provides 100% conversion of Fc to Fc⁺) was applied, m decayed markedly with time. Linearity between ln m and t confirms the pseudo-first order kinetics. When the potential was set at 0.0 V, m remained almost unchanged. Three independent measurements led to a kₐₚₚ^{0.8 V}=(6.0±0.5)×10⁻³ min⁻¹ and a kₐₚₚ^{0.0 V}=(0.5±0.2)×10⁻³ min⁻¹, indicating that the PVF/CF catalyst showed strong catalytic activity at 0.8 V and almost no activity at 0.0 V. A potential of 0.8 V applied to a bare CF matrix did not cause a concentration decay of MVK (FIG. 11). Chronoamperometry measurements (FIG. 12) show that the time scale for catalyst activation (i.e., converting Fc to Fc electrochemically) was ˜5 s. Scaling analysis (described above) suggests that under our experimental condition the reactant mass transport time scale was ˜0.1 s. Both these time scales were significantly shorter than the reaction time scale (1/kₐₚₚ^{0.8 V} is ˜167 min); hence the activation and transport processes had negligible influence on the determination of kₐₚₚ.

To demonstrate the unique ability of an ERHC system to control kinetics on demand and achieve multiple intermediate reaction rates, we applied a series of different potentials between 0.8 and 0.0 V to the PVF/CF system and measured the corresponding reaction rates. As shown in FIG. 5, panel c (bar), we obtained intermediate kₐₚₚ values that were higher than kₐₚₚ^{0.0 V} and lower than kₐₚₚ^{0.8 V}. FIG. 5, panel c also shows the rate constants predicted theoretically based upon the Nernst equation: k_{N}=k^{OX}β/(1+β), with β=exp(F(E−E⁰)/RT), where k^{OX} is the rate constant when the catalyst is completely oxidized (i.e., kₐₚₚ^{0.8 V}), F is the Faraday constant, E⁰ is the standard redox potential for ferrocene, determined to be 0.370±0.025 V from five CV measurements, R is the ideal gas constant, and T is the reaction temperature (298 K). FIG. 5, panel c shows that kₐₚₚ was generally consistent with k_{N}, but exhibited a less steep trend with decreasing potential than did k_{N}. Specifically, when the potential was at low values (0.0, 0.2 and 0.3 V), kₐₚₚ was larger than k_{N}. One possible explanation for the difference between kₐₚₚ and k_{N} is that the PVF coating may have been a multi-layer film whose redox composition did not exhibit an ideal Nernstian dependence on potential; only a redox monolayer can exhibit ideal Nernstian behavior. In a multi-layer film, each layer of ferrocene may experience a slightly different potential. Thus, ferrocene molecules at the outmost layer may still have been in the oxidized state even when the electrode surface was at potentials much lower than E⁰; note that the as-prepared PVF/CF system contained only Fc⁺.

RPE Simulation.

Next we investigated the charge transport process of the redox polymer coating in the PVF/CF hybrid. Understanding how charge transport occurs sheds light on the multi-layer structure of the polymer film, as well as allows the rational design of RPEs, which may find other applications beyond ERHC, such as sensing and energy storage. Charge transport in a RP film confined on an electrode surface occurs by two fundamental processes: electron exchange at the electrode/polymer interface and diffusional charge transfer in the bulk polymer film. The dependence of the peak current (Iₚ) on the scan rate (vₛ) in a linear potential sweep measurement can shed light on the charge transport mechanism of a RPE system. The slope of an ln Iₚ−ln vₛ plot (S_{IV}) is a sensitive descriptor of the interplay between a redox-active species and an electrode. For RP films with finite thicknesses, the value of S_{IV} lies between 0.5 and 1. S_{IV} approaches 1 when the film behaves like an ideal redox monolayer, the current response of which is governed by electron exchange at the electrode surface. S_{IV} is close to 0.5 when the redox centers of the film exhibit a semi-infinite linear diffusion behavior. For the PVF-coated CFs (10 min deposition) used for our catalysis experiments, scan rate-dependent CV measurements yielded an S_{IV} value of 0.66 (FIG. 6, panel a). Thus the redox transformation of the PVF layer was a combination of the two limiting case behaviors. It can be readily inferred from the S_{IV} value that the charge transport process within the PVF film is more diffusional than surface-limiting, characteristic of a redox multi-layer.

An important question is how “diffusional” is the RP film? Or, what is the thickness of the film that can yield an observed S_{IV} value determined by a mixed diffusional/surface-limiting behavior? To answer this question, we simulated the instantaneous current responses with varying film thicknesses employing a modified RPE model (FIG. 6, panel b) based on previous work by Bard et al. The redox polymer film is divided into Lₘₐₓ layers with an interlayer distance of d_{IL}. Direct electron exchange between the film and the electrode involves only the redox moieties immediately adjacent to the electrode (i.e., layer 1). Subsequent charge transfer to redox sites further from the electrode (i.e., layer 2 through Lₘₐₓ) is treated as a diffusional process; such a treatment has been widely employed for redox polymer films, and also specifically for PVF films. Details of the RPE simulation are described above. FIG. 6, panel c shows the simulated Iₚ values as a function of vₛ on a log-log scale. The scan rate range is the same as that used in FIG. 6, panel a. To show clearly the change in slope, Iₚ is normalized to the maximum current value obtained at the highest scan rate. It can be seen from FIG. 6, panel b that, with an increasing number of layers, the slope decreased, indicating increasing diffusional control of the electron transport processes. FIG. 6, panel d shows the S_{IV} values as a function of Lₘₐₓ, calculated from linear fitting of the simulated ln Iₚ−ln vₛ data. It could be readily seen that the slope decreased with increasing Lₘₐₓ, and that a Lₘₐₓ value of 36 yielded the S_{IV} value (0.66) experimentally observed for our PVF/CF catalyst. The S_{IV} did not approach 1 when Lₘₐₓ drew closer to 1 because we simulated Iₚ using the scan rate range that matched that adopted in the experiments. We further simulated Iₚ at very slow scan rate range from 0.001 to 0.02 V/s when setting Lₘₐₓ=1; linear fitting from the ln Iₚ−ln vₛ data yielded an S_{IV} value of 1.00 (FIG. 6, panel e), thus confirming the validity of this model. In our simulation, the only parameter with an arbitrary value was d_{IL}. The electron hopping distance between ferrocene molecules during a diffusional charge transport process was around 2 to 5 nm; thus we used a value of 2 nm for d_{IL} in FIG. 6, panels c-e. We also performed simulations using other d_{IL} values (1, 3, 5 and 7 nm). We found that with an increasing d_{IL} value, although the Lₘₐₓ value required to achieve the experimentally observed S_{IV} value decreased significantly from 86 to 17 (FIG. 6, panel f, square), the thickness of the film (i.e., d_{IL}×Lₘₐₓ) was similar, ranging from 68 to 84 nm (FIG. 6, panel f, circle), consistent with the thick thickness (62 nm) determined by neutron reflectivity for a PVF film with a similar ferrocene surface coverage. The RPE model is useful for extracting information, from dynamic electrochemical measurements, on the thickness of a thin redox-active layer coated around a porous electrode, which is somewhat difficult to determine by methods commonly used for thin films on flat electrodes.

Temporal Control in Batch Systems.

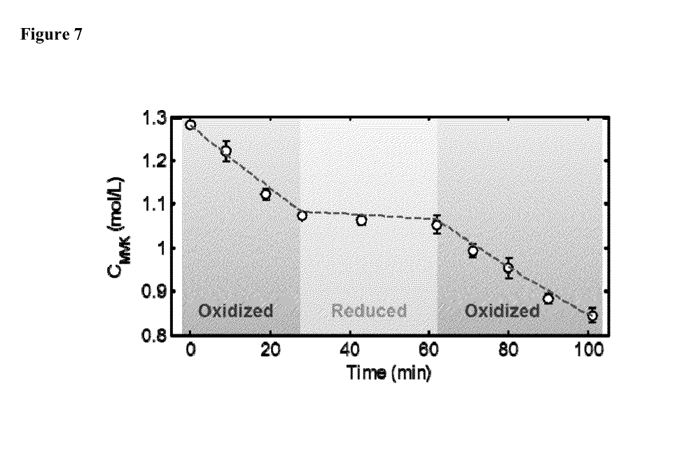

To demonstrate the ability of ERHC to exert temporal control over reaction kinetics, we followed the concentration of MVK in a batch reactor while using the electrochemical potential to modulate the catalytic activity of the PVF/CF hybrid at different times. FIG. 7 shows the concentration of MVK in mol/L (C_{MVK}) in the reaction medium as a function of time, with the electrochemical potential of the PVF/CF catalyst set to be at 0.8 V from 0 to 28 min (fully oxidized state), 0.0 V from 28 to 64 min (fully reduced state), and 0.8 V from 64 to 100 min. Switching in situ between 0.8 V and 0.0 V effectively turned the reaction on and off, respectively. In FIG. 7, C_{MVK} decayed in the first 28 min, remained almost unchanged for the next 36 min, and continued to decay afterwards. Such a concentration-time profile was consistent with the prediction (gray dash lines) based upon the batch reactor mass balance equations using the kₐₚₚ^{0.0 V} and kₐₚₚ^{0.8 V} values. This consistency also suggested that the activation/deactivation of the catalyst was rapid, causing no apparent discrepancy between the experimentally measured profile and the prediction (which assumed that the activation or deactivation process happened instantaneously). This rapid catalyst activation/deactivation should be attributed to the fast electron transfer kinetics of the ferrocene moiety.

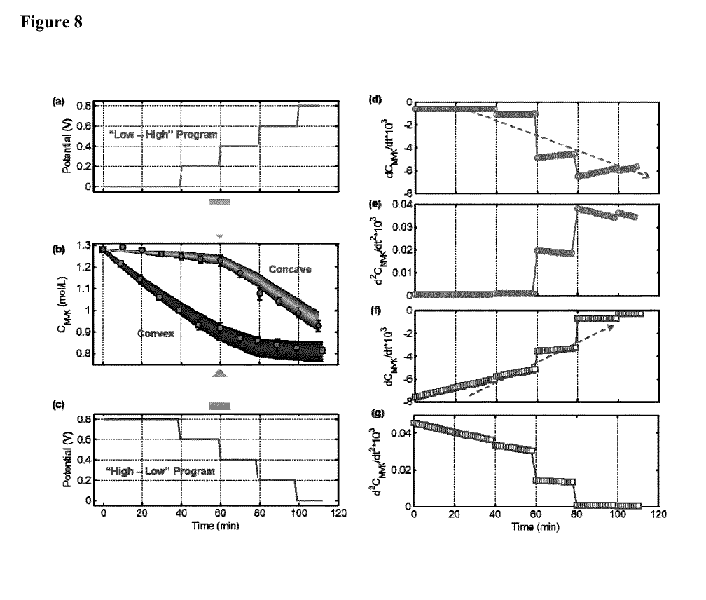

More interestingly, ERHC could be employed to create a complicated shape of the reactant concentration-time profile through applying a customized potential-time program. FIG. 8 shows such an example. By applying two different potential-time profiles, termed “low-high” (FIG. 8, panel a) and “high-low” (FIG. 8, panel c) programs, we obtained two very different C_{MVK}−t curves (FIG. 8, panel b). The “low-high” program resulted in a slow decay in C_{MVK} in the first 60 min followed by a fast decay from 60 to 112 min, whereas the “high-low” program led to a fast concentration decrease from 0 to 80 min and a slower decrease from 80 to 112 min. The two shaded bands with asymptotic color changes in FIG. 8, panel b were predictions from the batch system mass balance equations with first-order kinetics using the kₐₚₚ^{0.8 V}, kₐₚₚ^{0.6 V}, kₐₚₚ^{0.4 V}, kₐₚₚ^{0.2 V}, and kₐₚₚ^{0.0 V} values and their standard deviations. The experimental data (circles and squares in FIG. 8, panel b) were in good agreement with the predictions.

It is also interesting to note that, when employing the “low-high” program, the overall shape of the C_{MVK}−t curve exhibited a somewhat concave character, even though, in each segment with a constant potential value, the C_{MVK}−t relationship was convex in nature. This convex character is clearly seen on examination of the first and second derivatives of the calculated C_{MVK}−t curve: in each individual segment, the first derivative (dC_{MVK}/dt) was an increasing function of time (FIG. 8, panel d), and the second derivative (d²C_{MVK}/dt²) was positive (FIG. 8, panel e). In fact, it would be possible to obtain a “real” concave curve by using very small increments in potential, for example, using a linear potential-time function. On the other hand, with the “high-low” program, the C_{MVK}−t relationship exhibited a convex shape, with different decay constants (τ^{P}=1/kₐₚₚ^{P}, P is the applied potential with values of 0.0, 0.2, 0.4, 0.6, 0.8 V) in each constant-potential segment. The first and second derivatives in this case are shown in FIG. 8, panel f, and FIG. 8, panel g, respectively. A distinction between the “low-high” case and the “high-low” case could be also appreciated by comparing FIG. 8, panel d, with FIG. 8, panel f. In both cases, dC_{MVK}/dt in each individual segment was an increasing function of t. With the “high-low” program, dC_{MVK}/dt exhibited a general increasing trend with time (indicated by the dashed arrow in FIG. 8, panel f). However, with the “low-high” program, dC_{MVK}/dt exhibited a general decreasing trend with time (indicated by the dashed arrow in FIG. 8, panel d). This general decreasing trend gave rise to the apparently concave shape of the C_{MVK}−t curve in FIG. 8, panel b.

Temporal and Spatial Control in Flow Systems Demonstrated by COMSOL Simulation.

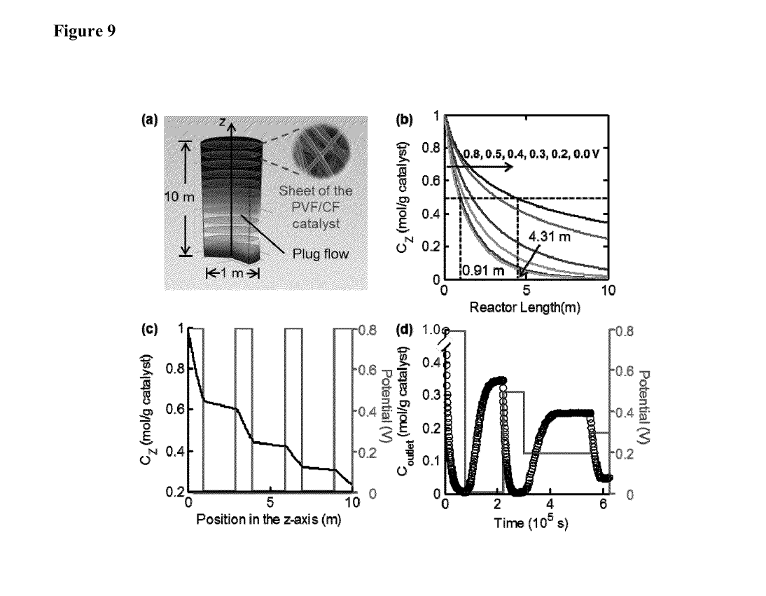

A distinct advantage of integrating ERHC into a flow reactor is the flexible control over reactant concentrations as a function of both location and time. We note that the spatial control in a flow reactor may be unique to an ERHC system, due to its heterogeneous nature combined with the fact that electrochemical stimulus could be applied locally with high precision. To demonstrate the capability of ERHC to exert both spatial and temporal control in a flow reactor, we performed COMSOL simulation on an ERHC-integrated packed-bed-like tube reactor, composed of ˜40,000 stacked PVF/CF sheets whose activity can be adjusted individually in real-time by changes in their electrochemical potential. The tube reactor model is illustrated schematically in FIG. 9, panel a. The reactor was taken to be 10 m long and 1 m in diameter, with a catalyst mass of 1700 kg and a packing density of 217 kg/m³. The inlet concentration of MVK was fixed at 1 mol/g catalyst. Simulation details are described above.

FIG. 9, panel b shows the concentration of MVK (C_{Z}) versus position along the z-axis of the reactor when a series of potentials were applied to all the catalyst sheets. Clearly, with increasing potential, C_{Z} decreased more quickly. For instance, when 0.0 V was applied, C_{Z} decayed by half at z=4.31 m, whereas with an applied potential of 0.8 V, C_{Z} decreased by half at z=0.91 m. Conceivably, more complicated concentration profiles can be obtained by applying different potentials at different positions within the reactor. FIG. 9, panel c shows such an example: a step-like concentration profile was obtained through application of a square-wave-like potential profile. To further demonstrate temporal control, we arbitrarily changed the potentials of all the catalyst sheets over time (FIG. 9, panel d, line). Consequently, an interesting relationship between the outlet concentration of MVK (Cₒᵤₜₗₑₜ) and time was predicted (FIG. 9, panel d, circles). In this case, an initial condition with a uniform MVK concentration of 1 mol/g catalyst throughout the reactor was applied. The results shown in FIG. 3, panel e, and FIG. 3, panel f suggest that ERHC allows flexible spatial and temporal manipulation of reactant concentrations; such a high degree of flexibility is almost unattainable using conventional control strategies.

Tests of Other Reactions.

In addition, we measured kₐₚₚ values for six other Michael addition reactions using the PVF/CF catalysts (10 min deposition); the results are summarized in FIG. 10. Reactions in panels (a), (b), (c) and (d) were found to show much higher kₐₚₚ values under the completely oxidized state (i.e., 0.8 V) than at the completely reduced conditions (i.e., 0.0 V). We also tested one intermediate potential (0.3 V), which gave rise to a rate between the kₐₚₚ^{0.0 V} and kₐₚₚ^{0.8 V} values, for these four reactions. Results shown in FIG. 10, panels (a)-(d) indicate that the ERHC control strategy could also be applied to these four reactions using the PVF/CF hybrid. However, the kₐₚₚ values for reactions in panels (e) and (f) were very low, and showed no significant difference across different potentials. This suggests that the ferrocenium ion does not catalyze these two reactions. It was found previously that, for iron (III) catalysis of the Michael reaction of β-dicarbonyl compounds and enones, fast kinetics were observed for reactions involving either cyclic ketoesters or methyl vinyl ketone or both. Reactions in panels (e) and (f) involve neither ketoesters nor methyl vinyl ketone.

### Example 2

### Polyvinylferrocene/Polypyrrole Hybrids for Energy Storage

Electrode Fabrication.

Non-Teflon treated Toray carbon fiber paper (EC-TP1-060) was cut into 1-cm by 2-cm rectangles as the electrode substrate. Polymer electrodes are prepared by direct electrochemical deposition of PVF and pyrrole in Chloroform. Electrode (CF-Codep) was prepared by immersing 1-cm×1-cm of the carbon paper into electrolyte solution (0.104 M pyrrole and 1 mg/mL PVF, 0.1 M TBA-ClO₄ in CHCl₃), and apply a constant current density 2 mA/cm² to working electrode. Electrodes with coreshell structures were prepared by depositing PVF or polypyrrole sequentially. PVF was deposited by applying 0.8 V potential while immersing electrodes in CHCl₃ containing 1 mg/mL PVF, while polypyrrole was deposited by applying 2 mA/cm² current density while electrode is immersed in 0.104 M Pyrrole and 0.5 M NaClO₄ solution. All depositions are performed for 5 min.

Electrochemical Characterization.

Electrochemical polymerization and characterizations are all performed using an AutoLab PGSTAT 30 potentiostat and GPES software, version 4.9 (Eco Chemie). Cyclic voltammetry and galvanostatic discharge measurements were conducted in 0.5 M sodium perchlorate solution in both the three-electrode system and the two-electrode system. In the three-electrode cell, Pt wire and Ag/AgCl were used as the counter electrode and the reference electrode, respectively. The two-electrode cell was fabricated by sandwiching a filter paper between two polymer-deposited carbon paper electrodes. The electrode-filter paper-electrode set-up was then inserted between two glass slides for support. The electrochemical impedance spectroscopy (EIS) measurements on the two-electrode supercapacitor cells were performed in the frequency range of 100 kHz to 0.01 Hz with an electrochemical impedance analyzer (Gamery EIS300™).

Polymer Characterization.

Nitrogen adsorption/desorption was conducted on an automatic volumetric adsorption analyzer (Micromeritics ASAP2020). The PVF/PPy polymer hybrid films were first deposited on stainless steel sheets and then peeled off for the N₂ physisorption measurements. XPS was performed with a PHI Versa Probe II. The X-ray used was set at 200 μm, 50 W and 15 kV. An XPS full scan survey was performed with a pass energy of 187.85 eV in the 0-1100 eV binding energy region. Angle-resolved XPS was performed with a argon single-ion gun for depth profiling. Changes in elemental composition within the polymer films up to 10 nm in depth were recorded nondestructively at various sample tilt angles relative to the analyzer, with values of 20°, 45°, and 90°. To allow depth profiling, the angle-resolved XPS was performed on polymer hybrid films that were deposited on a flat stainless steel sheet in the absence of carbon fibers. XPS survey scans were analyzed using the CasaXPS software. The spectra were calibrated with the C₁ₛ peak (284.8 eV). The quantification regions are subtracted using a Shirley background.

Small-angle neutron scattering (SANS) was performed on the D22 diffractometer at Institut Laue-Langevin, Grenoble, France. The neutron wavelength used was κ=10 Å at two different detector distances and a Q value between 0.0024 and 0.37 Å⁻¹ was realized. The absolute cross section I(Q) (cm⁻¹) as a function of momentum transfer Q (Å⁻¹) was obtained via data normalization. The measurements were performed in Hellma fused silica cuvettes with a path length of 2 mm. To provide the necessary contrast, the dilute polymer aqueous systems were measured at 5 mg mL⁻¹ in d-chloroform (scattering length density p=3.11×10¹⁰ cm⁻²). Data analyzed were in absolute units based on the sample compositions. A flat background term was employed to account for any low level of residual incoherent scattering during the fitting process. UV-vis absorption experiments were performed with Evolution™ 201/220 UV-Visible Spectrophotometers (Thermo Scientific). Fourier transform infrared spectroscopy (FT-IR) was measured on Nicolet NEXUS. Thermogravimetric analysis of the prepared electrodes was conducted using Q50 TGA (TA Instruments). Samples were equilibrated at room temperature, followed by ramping from room temperature to 900° C. at a heating rate of 5° C. min⁻¹.

Surface Morphology Characterization.

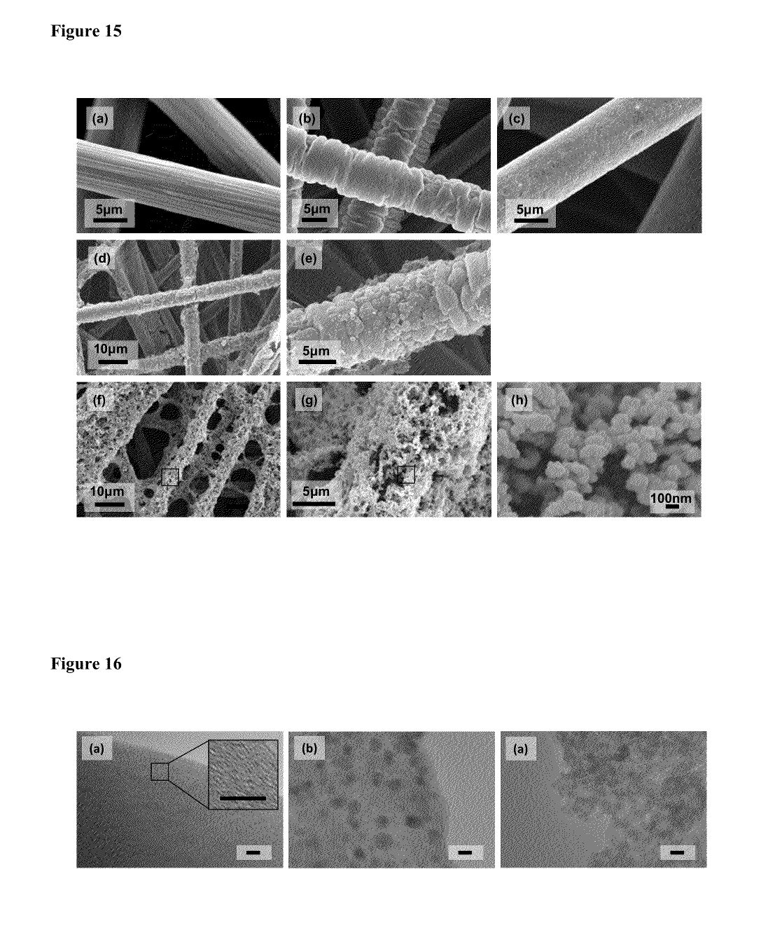

Scanning electron microscopy (SEM) and high resolution (HR)-SEM were used to study the surface morphology of prepared samples. Commercial available Toray carbon fiber paper was employed as the polymer substrate to provide structural support for the studied polymer films. The pristine carbon fiber shows clean fiber surface with longitudinal striation patterns characteristic of Toray fibers (FIG. 15, panel a). Each fiber is of ca. 10-μm diameter and has the advantages of offering more nucleation sites for polymer deposition while maintaining the porous electrode architecture at a large scale. Both PPy and PVF are shown to be conformally coated onto the carbon fibers through electrochemical deposition. PPy itself results in a segmented, but smooth and densely grown film on each fiber (FIG. 15, panel b), which is consistent with the reported homogenous, closely packed, globular-shape structure of PPy. Similarly, pure PVF film gives a nonporous, but relatively rough morphology on each fiber.

Polymer films of two different hybrid architecture, coreshell and codeposition, are compared. Coreshell structured film consisting of PPy as the inner layer and PVF as the outer layer (CF-PPyPVF) (FIG. 15, panel c) exhibits more roughness at the surface, compare to the pure PPy film, but the dense film morphology is still maintained. In contrast, the codeposited film shows highly porous 3-D structure (FIG. 15, panel e). This interconnected porous morphology is observed consistently throughout the entire carbon fiber framework (FIG. 15, panel f). Close examination via HR-SEM reveals that the codeposited film consists of nanoscale polymeric spherical clusters with diameters of 50-100 nm (FIG. 15, panel f). These nanospheres, albeit randomly adhere to each other, form an interconnected porous network with carbon fiber as the retaining framework. Within the polymer/carbon fiber composite, a hierarchical porosity is observed comprising a consistent nanostructured order within the polymer film and microscale porosity from the interfiber spacing. This morphology offers a large interfacial area between the polymer and electrolyte thus can potentially facilitate better ion diffusions, thus rendering excellent electrochemical properties. The significantly different morphology property of the two polymer hybrids implies two different polymerization/precipitation processes, which motivates us to further investigate the precipitation process in later sections.

Transmission electron microscopy (TEM) image of polypyrrole polymer film shows absence of any irons. The electrochemically polymerized polypyrrole show crystalline regions under TEM with an interchain distance of 0.2 nm. Crystallization in polymers involves small crystallites of aligned chains interspersed with regions where the chains are disordered. The presence of crystalline nano-domains is characterized by π-π interactions between adjacent polypyrrole polymer chains. TEM image of drop casted PVF (FIG. 16, panel a) show distinct circular ferrocene clusters with diameters range from 2 nm to 5 nm within the polymer film (FIG. 16, panel b). In comparison, the embedded iron atoms are more dispersed within the codeposited hybrid film (FIG. 16, panel c).

Nitrogen adsorption was used to characterize the pore structure of the co-deposited polymer hybrid. The adsorption isotherm, or volume adsorbed versus relative pressure, P/P₀, where P₀ is the saturated vapor pressure, displayed a steep increase in slope at relative pressures above 0.8, and a hysteresis loop between the relative pressures of 1 and 0.8 on desorption (FIG. 22, panel a). This is a Type V isotherm according to the IUPAC classification, and indicates the presence of mesopores (2-50 nm) within the polymer hybrid in which capillary condensation occurs at high P/P₀. The exhibited hysteresis is a result of the different pressures at which capillary condensation and capillary evaporation occur. The specific surface area of the polymer hybrid obtained by the Brunauer-Emmett-Teller (BET) analysis is 166.8 m² g⁻¹, which is significantly higher than values reported for pure polypyrrole (37-61 m² g⁻¹), such as polypyrrole porous clusters, tubes, nanoparticles, and thin films, or pure PVF powder (8 m² g⁻¹). The pore size distribution based on the Barret-Joyner-Halenda (BJH) theory (FIG. 22, panel b) displays a broad peak in the region of 5-80 nm, with an average of 26.0 nm and a maximum at 33.0 nm. This broad distribution of pore sizes is consistent with the combination of mesopores (2-50 nm) and macropores (>50 nm) observed in the polymer hybrid under SEM. This broad distribution of pore sizes can potentially enhance ion access to the electroactive polymers and improve the power capability of the hybrid.

Composition and Structure Characterization.

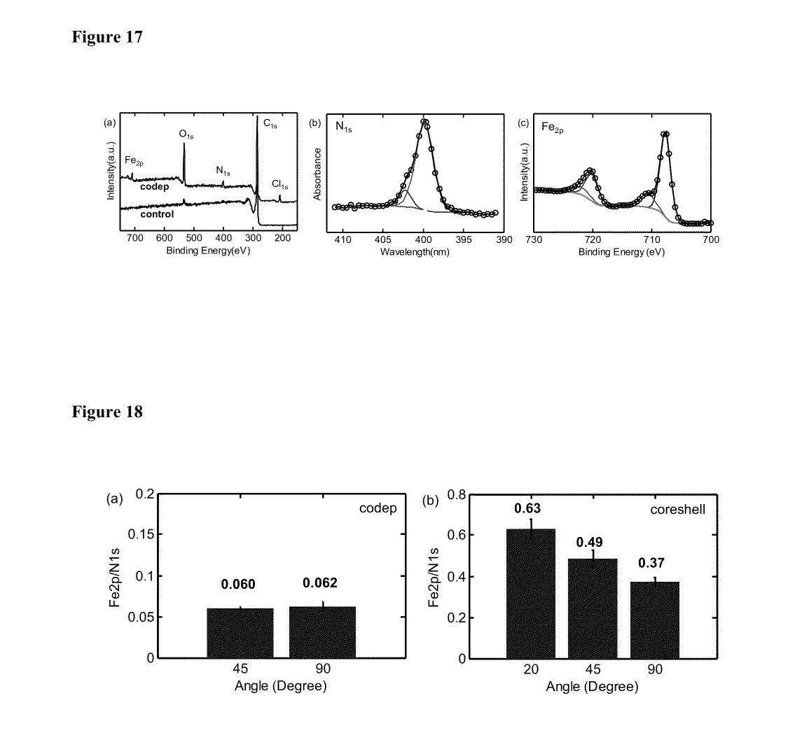

Surface elemental analysis was performed via XPS to study the prepared polymer electrode architecture. Since iron only present in PVF and nitrogen only present in PPy, the Fe2p and N1s signals serve as unique elemental markers for the corresponding components and were thereofre used to determine their surface concentration using XPS. A XPS full scan survey of the sample in comparison with the pristine Toray carbon paper (FIG. 17, panel a) indicated the presence of C1s, O1s, N1s, Cl and Fe2p photoelectron peaks. The presence of Cl 1s and the increased O 1s signal result from the dopant ClO₄⁻ used in the polymerization.

To confirm the prepared polymer electrode architecture, angle-resolved depth profiling was performed using PHI Versaprobe II (C60 cluster-ion gun/a floating voltage argon single-ion gun for depth profiling). Changes in elemental composition within the polymer films up to 10 nm in depth were recorded nondestructively by varying the sample tilt angle relative to the analyzer. The depth at which the composition was detected increases as the tilt angle increases. The deconvoluted high-resolution N1 s spectra and Fe2p are shown in FIG. 16, panel b, and FIG. 16, panel c. The N1s spectra is deconvoluted into two peaks with the main component peak at 399.8 eV, and a second peak at 402.2 eV, which correspond to the neutral-NH— nitrogens and the oxidized C—N⁺ nitrogen, respectively. The peak positions observed in the present work are in good aggreement with literature values. The Fe2p display Fe2p_{1/2} and Fe2p_{3/2} signals, where each signal is deconvoluted into two peaks. The smaller peaks at higher binding energies result from the partially oxidized ferroceniums. Peak intensity information can be used to obtain the relative atomic concentration. The Fe2p/N1s ratio gives the ratio of Ferrocene unit to Pyrrole unit in the polymer hybrid. Fe2p/N1s decreases from 20 to 90 degree tilt angles, indicating more pyrrole presenting from the outer surface into the polymer film for the coreshell polymer film (FIG. 16, panel b). For the codeposited polymer film, the ratio stay approximately same throughout the analyzed depth, indicating that PVF is more uniformed distributed within the polymer hybrid comparing to the coreshell sample (FIG. 18, panel a). It is also interesting to point out that, in the codepositon sample, Fe2p content is only ca.6% of N1s. This is consistent with the ferrocene moiety concentration in the deposition solution, where the molar ferrocene unit concentration is ca. 5% of the pyrrole monomer. While for the coreshell structured sample, the PVF depositions in the second step allows more PVF to deposit at the outer layer, thus Fe2p has a much higher atomic percent overall.

Electrochemical Characterizations.

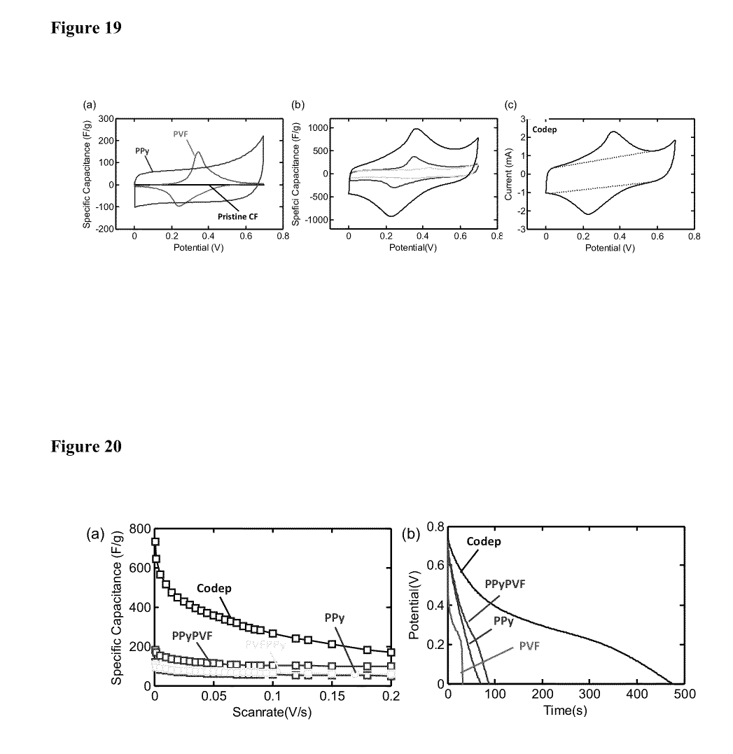

The observed interesting surface morphology of the polymer hybrid shows exciting prospect for its application in electrochemical systems. To investigate the electrochemical behavior of the polymer hybrid systems, various polymer deposited electrodes are prepared and are referred to as substrate-deposited polymer. For example, CF-PVF refers to the PVF deposited carbon fiber, and CF-PPyPVF refers to the coreshell structured polymer films on carbon fibers where PPy is the inner layer and PVF is the outer layer. Here, CF, CF-PPy, CF-PVF, CF-PPyPVF, CF-PVFPPy, and CF-codep were prepared and evaluated in 0.5M NaClO₄ aqueous electrolyte system. Cyclic voltammetry of the prepared electrodes are performed to evaluate their capacitance behavior (FIG. 19).

In FIG. 19, panel a, the pristine carbon fiber paper works as an inert substrate with negligible capacitance contributions. Electrochemically polymerized PPy film has a quasi-rectangular shape CV curve with no distinct redox peaks within a voltage window from 0V to 0.7V. The near rectangular profile indicates the charge-discharge responses of the PPy film are highly reversible and kinetically facile. At higher scan rate, the CV shaper become distorted, due to the entering into, rejecting and diffusion of counter ions being too slow compared to the transfer of electrons in the PPy matrix at high scan rate, In contrast, the deposited PVF film shows distinct oxidation and reduction peaks, at 0.35V and 0.25V respectively. The observed peak potentials are in fair agreement with the redox potential of PVF modified electrodes. It is exciting to see that when both PVF and PPy present in the hybrid polymer films, the CV curve shows a combination of PPy's broad quasi-rectangular profile with distinct redox peaks from PVF.

To investigate the capacitive behavior of the hybrid polymers electrode with different architectures, the corresponding CV curves are shown in FIG. 19, panel b. The codeposited sample gives much higher specific capacitance compared to the two core-shell structured samples. To further evaluate the specific capacitance increase of the codeposited sample, the contribution from PVF and PPy is analyzed by dividing the CV profile based on the shape and assuming that the PPy exhibits the same CV profile within the polymer hybrid (FIG. 19, panel c). The mass of each polymer component, PPy and PVF, is determined from thermogravimetric analysis (TGA). The capacitance of each component is calculated via dividing the total capacitance by the respective mass. The specific capacitance of PPy is determined to be 377 F/g, and that of PVF to be 1014 F/g at 0.010 V/s scan rate. This significant increase of both polymer components, especially PVF, demonstrated the excellent electrochemical behavior of the material. The enhanced charge storage capacity indicates an increased utilization efficiency of both PVF and ion accessibility of polypyrrole. This interesting synergistic effect is a result of the formed porous structure.

Energy Storage and Supercapacitor Applications.

The rate performance of the polymer electrode is also investigated at scan rates of 0.001 V/s to 1 V/s. The specific capacitance values calculated for the electrodes are compared in FIG. 20, panel a. CF-PPy and CF-PVFPPy have similar specific capacitance because PVF is imbedded inside the densely grown PPy layer. The inner layer PVF cannot be fully oxidized due to the limit access to electrolyte solution. This is consistent with the corresponding CV profile (FIG. 19, panel b), where the PVF redox peak is suppressed compared to electrodes of other architectures. Aside from the morphological drawback, the electron conducting property is also compromised, without conjugate backbones, PVF cannot conduct electrons along the polymer chains, thus can provide limited electron access to the outer-layer PPy, which ultimately result in the relatively low overall capacitance. CF-PPyPVF has a coreshell structure of PPy inner layer and PVF outer layer. Its specific capacitance is higher than that of the pure polymer component, PPy and PVF, combined, and that of the CF-PVFPPy electrode. This interesting coreshell structure, though, shows a more rough surface morphology (FIG. 15, panel d, and FIG. 15, panel e), has densely grown and nonporous film structure. Thus, ion diffusion limitation within this polymer film is still expected, can lower accessibility of redox sites deeper imbedded in the matrix. Different from CF-PVFPPy, the inner layer PPy is conducting thus can provide better electron transport within the system, thus exhibits relative higher specific capacitance than CF-PVFPPy. CF-codep show much higher specific capacitance than all the other electrodes. This is due to the observed 3D porous nanostructure. The hybrid nanoporous polymer film allows easier ion diffusion within the films, thus facilitate the ion insertion and extraction during the doping and dedoping of PPy. The nanoscale porous structure reduces the characteristic length scale for ion diffusion and results in efficient charge propagation.

Galvanostatic charge and discharge profiles were also obtained to study the materials' electrochemical properties. The discharge profile of PVF starts with a sudden decrease in potential, followed by a flat-potential region as a result from the reduction of the ferrocenium to ferrocene. Once all the ferrocenium units are reduced, the potential quickly plunges to zero. This profile is consistent with what has been reported in literature. In contrast, the curve for PPy is highly linear and symmetrical. The profile does not exhibit any significant decrease in slope because the PPy has no defined redox potential within the potential window tested, which is consistent with the featureless quasi-rectangular CV profile (FIG. 15, panel a). Both the codeposited and coreshell electrodes show deviations from a linear profile due to the pseudocapacitive contribution from the redox behaviors of PPy and PVF. The charging potential profile shows a decrease in potential change rate around 0.35 V; the discharge potential profile show decrease in potential change rate around 0.25 V. This potential flatness corresponds to the redox reactions of ferrocene centers. It is clear that the discharge profiles of the hybrid systems exhibit the characteristics of both PVF and PPy. However, the codeposited polymer hybrid shows much broader discharging profile than the coreshell structured sample, indicating a much larger charge storage capacity. The similar trend of charge storage capability is also observed by comparing the CV profiles in FIG. 15, panel b.

TABLE 1
The calculated specific capacitance of
various polymer systems at 10 mV/s.

| Polymer system | Specific Capacitance (F/g) |
|---|---|
| PPy | 79 |
| PVF | 27.3 |
| PVFPPy | 103.2 |
| PPyPVF | 144.1 |
| Codeposited PVF/Ppy hybrid | 514.1 |

In addition, we also compared the performance of the PVF/PPy hybrid with a broad range of alternative supercapacitor electrode materials for energy storage applications, such as porous carbons and various inorganic electroactive species (data not shown). This comparison shows that the PVF/PPy hybrid has a higher specific capacitance than most of the recently reported carbon-based supercapacitor materials, such as corncob residue derived carbon, nitrogen-containing carbon microspheres, etc. This is due to the pseudocapacitance contribution from both PVF and PPy. Compared to the recently reported transition metal oxide/porous carbon composite materials, the PVF/PPy hybrid has a comparable or slightly higher specific capacitance. Different from metal oxide/carbon composites, the PVF/PPy hybrid is fabricated from a facile electrochemical co-deposition method, which can potentially be generalized to various other metallocene-containing polymers and conducting polymers. In addition, the hybrid polymer film can also be combined with various carbon nanomaterials, such as carbon nanotubes or graphene, to further improve its properties.

Electrochemical Polymerization and Precipitation Process.

The drastically different surface morphology and enhanced charge storage capacity of the polymer hybrid motivate us to seek a better understanding of the polymerization and precipitation process. In the codeposition solution, each PVF polymer chain is surrounded by pyrrole monomers in solution. Upon polymerization of pyrrole, PVF molecules are encapsulated and woven into the interpenetrating polypyrrole network. The PVF polymer chain conformation change due to interaction with pyrrole is captured using SANS. This interaction is further studied using UV-vis absorbance spectrum.

SANS Analyses Confirm Polymer Coil Conformation Change.

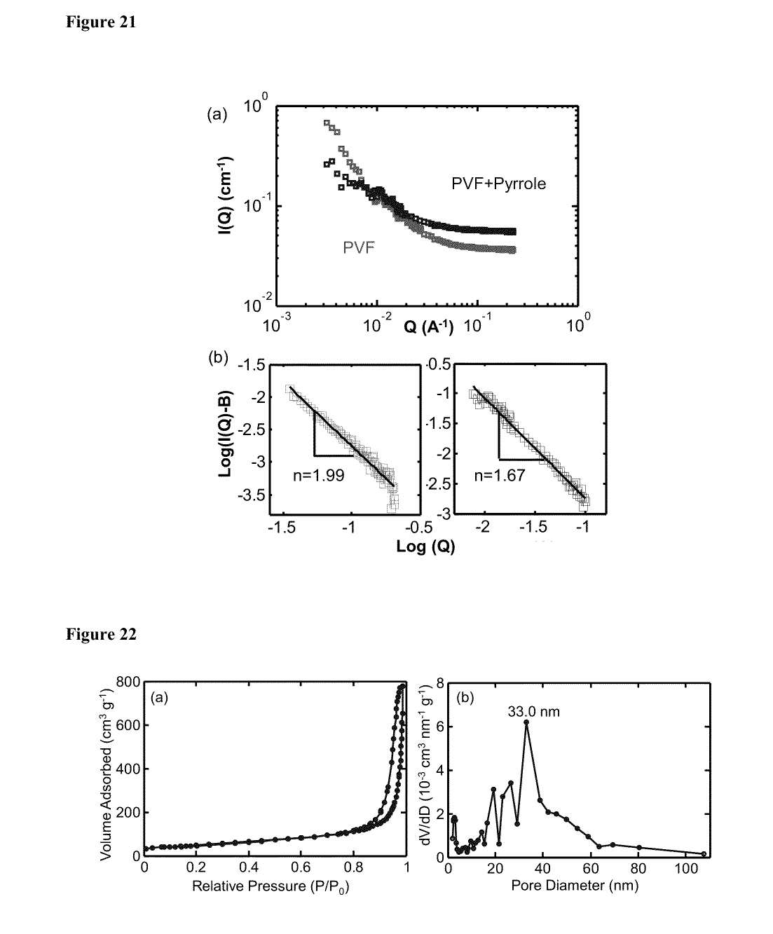

Small-angle neutron scattering (SANS) is a sensitive technique that can be used to probe the conformation of the PVF polymer chains in solution. The SANS results of pure PVF and PVF with pyrrole in CHCl₃ solutions are shown in FIG. 21. Prior to subtraction of the incoherent background, the intensity of PVF in present of pyrrole shifts up compare to pure PVF. This shifting of intensity is due to the present of H from pyrrole. As the intensity curve indicates, PVF loses the Gaussian coil structure in the presence of pyrrole. This is also confirmed by the Porod analysis, which can reveal the local structure of the polymer, the “fractal dimension” of the scattered polymer coil. In high Q region (Porod region), the intensity can be expressed as

$$I ( Q ) = \frac{A}{{Q}^{n}} + B$$

For polymer coils, the Porod slope n can be extracted by plotting Log(I(Q) vs. log(Q). n is related to the excluded volume parameter v, as in n=1/v. Gaussian coil has a Porod slope of 2, swollen coil has a Porod slope of 5/3, and a collapsed polymer coil has a n value of 3. PVF in CHCl₃ gives a n value of 1.99, whereas PVF with pyrrole present gives a value of 1.67, which indicate that PVF along in CHCl₃ exist as Gaussian coil, while when pyrrole monomers present in solution, the PVF interact with pyrrole and gets extended, thus exist as a swollen coil. The increase in measured radius of gyration again confirmed the structural change of PVF in solution due to interaction with pyrrole. To obtain the polymer radius of gyration, a Lorentzian form for the Q-dependence of the scattering intensity is assumed. By plotting 1/I vs. Q², one can extract the value of I₀ and ζ, where ζ is the correlation length, and proportional to the Flory-huggins interaction parameter (incompressible RPA model).

$$I ( Q ) = \frac{{I}_{0}}{1 + {Q}^{2} {ζ}^{2}}$$

In the low-Q region I(Q) can be simplified as

$$I ( Q ) = \frac{{I}_{0}}{1 + \frac{{Q}^{2} {R}_{g}^{2}}{3}} = {I}_{0} ( 1 - \frac{{Q}^{2} {R}_{g}^{2}}{3} + … )$$

Thus, in low-Q region, ζ=(R_{g}/√3). The radius of gyration estimated for PVF is 5.9 nm in CHCl₃, and increased to 7.5 nm when pyrrole molecules are present in solution, which is ca. 30% increase in R_{g}.

UV-Vis Analyses Indicate Molecular Interactions Between Pyrrole and PVF.

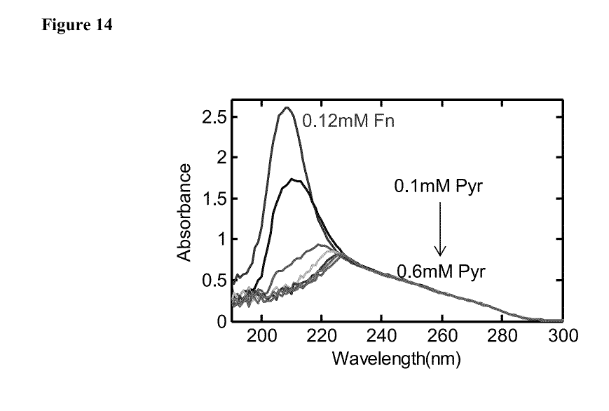

To further understand the molecular interactions between pyrroles and PVF chains in solution, UV-vis is used to study the interaction between the cyclopentadiene ring within PVF and the 5-membered heterocyclic aromatic rings in pyrrole. Pyrrole exhibits a characteristic peak around 210 nm, while PVF has a characteristic energy absorption band around 200-220 nm that corresponds to the π→π* transition of the cyclopentadiene ring of the ferrocene molecule. The UV-vis absorption of ferrocene with pyrrole is shown in FIG. 14. The ferrocene absorption peak decreased gradually as the pyrrole concentration is increased from 0.1 mM to 0.6 mM. The significant suppression of ferrocene absorption peak indicates intimate molecular interaction between pyrrole and ferrocene in solution, which be a result of a greater extended molecular packing between the cyclopentadiene ring in PVF and the heterocyclic aromatic ring in pyrrole. The π→π* transition can result in hypochromism (decreased UV absorption) due to the decreased HUMO-LUMO energy gap, compared to the HOMO-LUMO gaps in either aromatic alone, thus, a longer wavelength absorbance is seen upon complexation.

Two-Electrode Symmetric Supercapacitor Device Performance

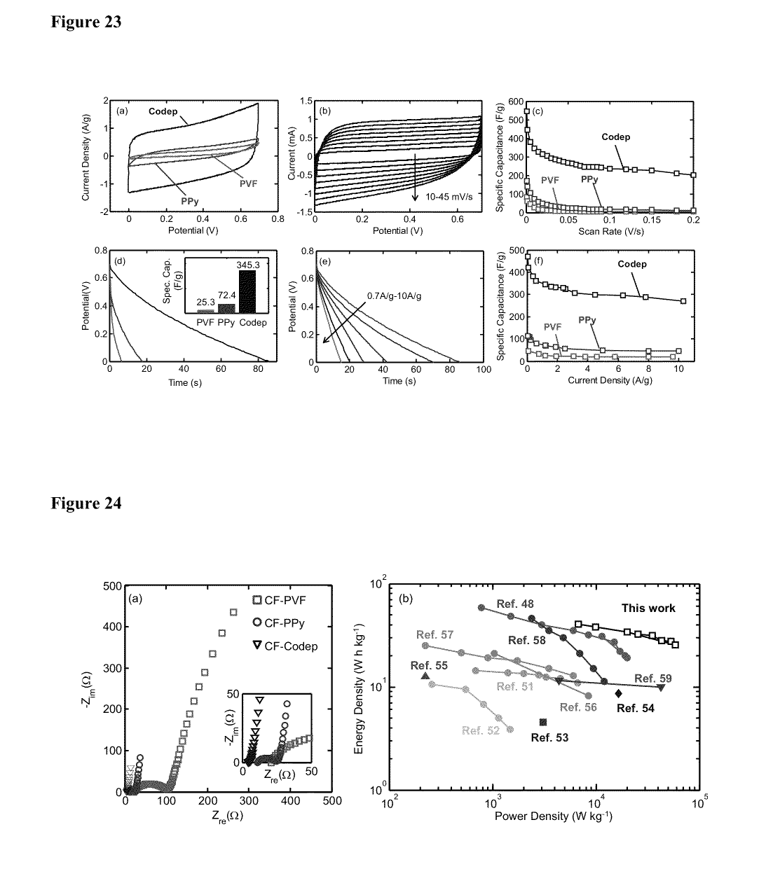

We also assessed the polymer hybrids in a two-electrode system that resembles the physical configuration in, and the operating conditions of, commercial packaged supercapacitors; our purpose in doing so was to provide a more meaningful measure of the material's performance for commercial applications. FIG. 23, panel a compares the CV profiles of PVF, PPy, and the co-deposited PVF/PPy hybrid. The co-deposited hybrid gave a much larger current response than did the PVF and PPy films, and displayed a quasi-rectangular CV profile. The disappearance of redox peaks in the two-electrode configuration is commonly seen in electroactive polymers, for reasons that are as yet unclear. As the scan rate increased, the CV profiles for the co-deposited hybrid showed slight distortions from the quasi-rectangular shape, due to the increasing overpotential from the ion transport within the polymers (FIG. 23, panel b). The galvanostatic discharge curves (FIG. 23, panels d and e) indicated the much higher charge storage capacity of the hybrid polymer compared to those of pure PVF and pure PPy films. The calculated specific capacitance at various scan rates from 0.001-0.2 V s⁻¹ and at various current densities from 0.06 to 10 A g⁻¹ demonstrated the excellent rate performance of the co-deposited polymer film in the two-electrode cell (FIG. 23, panels c and f). The co-deposited PVF/PPy hybrid exhibited a specific capacitance of 345.3 F g⁻¹, which is significantly higher than that of either PVF or PPy (FIG. 23, panel e).

To gain further insight into the advantages of the co-deposited hybrid structure, electrochemical impedance spectroscopy (EIS) measurements were conducted on the two-electrode supercapacitor cells; the resulting Nyquist plots for CF-PVF, CF-PPy, and CF-Codep are shown in FIG. 24, panel a. Compared to CF-PVF or CF-PPy, CF-Codep exhibited a lower solution resistance (Rₛ, determined by the intercept on the Zᵣₑ axis) and a lower interfacial charge transfer resistance (R_{ct}, indicated by the diameter of the charge transfer semicircle or the length of the Warburg region). Such decreases in Rₛ and R_{ct} further suggest that the ion diffusion resistance was reduced because of the formation of a porous structure and enhanced electron transport properties that result from incorporation of the conducting polymer component. The Coulombic efficiency was calculated to be 99.5% for the co-deposited polymer hybrid at a current density of 5 A g⁻¹. The power and energy densities determined from galvanostatic charge/discharge measurements in a two-electrode system are given in the Ragone plot shown in FIG. 24, panel b. This capacitor cell was characterized by a high energy density of 40.7 W h kg⁻¹ at a power density of 6.79 kW kg⁻¹; the energy density decreased by only about 40% to 25.4 W h kg⁻¹ following a significant ˜9-fold increase in the power density to 58.6 kW kg⁻¹. This enhanced power density at the expense of a relatively small decrease in energy density is attributed to the facilitated ion diffusion within the porous polymer films. The achieved maximum energy density is comparable to that of lead acid batteries (25-40 W h kg⁻¹) and much higher than that of activated carbon-based supercapacitors (4-5 W h kg⁻¹). Compared to some of the recently reported conducting polymer-based supercapacitor devices, the PVF/PPy hybrid-based supercapacitor gives a higher energy density due to the additional pseudocapacitance offered by PVF.

Cycling Stability.

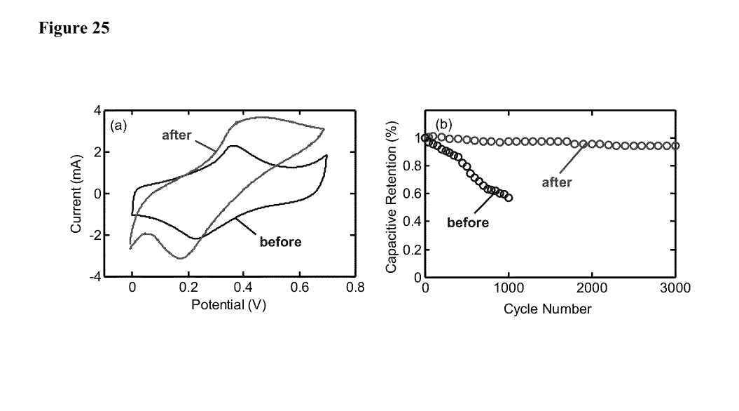

Conducting polymers usually have limited cycling stabilities due to repeated volumetric swelling and shrinking during charging/discharging. The volume change and the resulting mechanical stress often lead to mechanical degradation and dissolution of polymer films, as was also observed in the PVF/PPy polymer hybrid in this study. To address this cycling degradation issue, we utilized a hydrothermal process to deposit a thin layer of carbonaceous material on each of the hybrid clusters to mitigate the effects of the swelling and deswelling of the material during cyclic charging/discharging process. In the hydrothermal process, glucose was converted under mild conditions to a nanometer-thick carbon shell coating the materials. This method has been used to improve the stability of conducting polymers and metal oxides without compromising their electrochemical performance. The porous structure of the polymer hybrid was maintained during the hydrothermal coating process as observed by SEM, BET surface area, and pore size distribution. XPS analysis on the PVF/PPy hybrid after the hydrothermal process indicated the presence of the carbon coating on the polymer surface. FIG. 25, panel a compares the CV curves for the PVF/PPy hybrid observed in a 3-electrode system before and after the hydrothermal treatment. The deposition of the thin carbon shell resulted in a distorted CV profile, but with a slight increase in the capacitance due to the increased double layer effect from the carbon shells. EIS results and the calculated specific capacitance from both the CV and galvanostatic measurements confirmed that the electrochemical performance was not compromised by the hydrothermal process. The polymer hybrid retained 94.5% of its specific capacitance after 3000 cycles at 5 A g⁻¹ (FIG. 25, panel b), and exhibited minor changes in its surface morphology after the cycling evaluation.

Molecular Interactions Between Ferrocene and Pyrrole.

The different surface morphology and enhanced electrochemical properties of the polymer hybrid relative to the sequentially deposited components was due to the influence of intermolecular interactions between the PVF and pyrrole molecules on the simultaneous electro-polymerization and electro-precipitation process. In the co-deposition solution, each PVF polymer chain was solvated partially by pyrrole because PVF-pyrrole interactions are more favorable than those between PVF and CHCl₃ due to the π-π stacking interactions. Upon electro-deposition of the swollen PVF coils, the solvating pyrrole molecules were in a position to be electro-polymerized to form polypyrrole; the PVF molecules were incorporated into and intimately associated with the PPy in the resulting film. The change in PVF polymer chain conformation in solution prior to deposition due to its interaction with pyrrole was revealed using small-angle neutron scattering (SANS) and UV-vis absorbance spectrometry. This intimate interaction between the two polymers within the formed hybrid was further elucidated via Fourier transform infrared spectroscopy (FTIR).

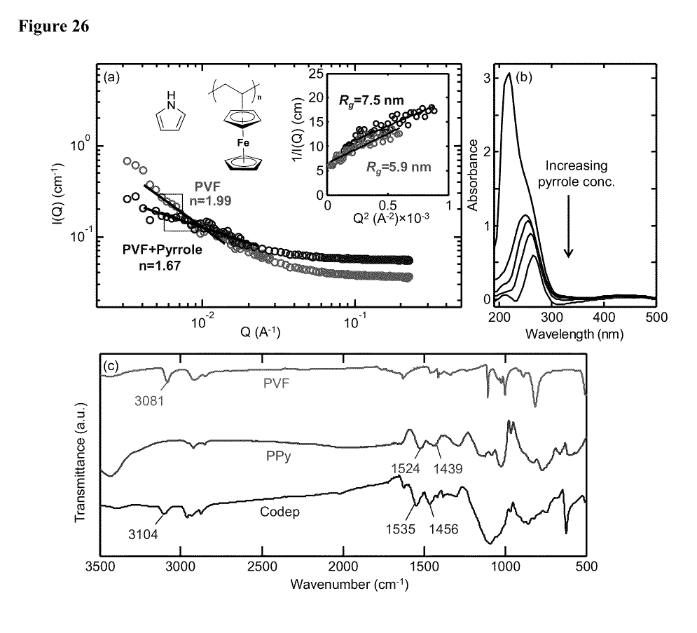

As described above, small-angle neutron scattering (SANS) was used to probe the conformation of the PVF polymer chains in solution. It is evident from the two different SANS profiles (scattering intensity I(Q) vs. Q=(2π/Δ)sin(2θ), where θ is the scattering angle, and λ the radiation wavelength) shown in FIG. 26 that PVF underwent conformational changes in the presence of pyrrole. Porod analysis confirmed this change by yielding information on the “fractal dimension” of the polymer coil. In the high-Q region, the intensity was approximated as:

$$I ( Q ) = \frac{A}{{Q}^{n}} + B$$

For polymer coils, the Porod slope n was extracted by plotting log (I(Q)−B) vs. log (Q) (FIG. 26), where B is the background. The exponent n is related to the excluded volume parameter v by n=1/ν; Gaussian, swollen, and collapsed coils have Porod slopes of 2, 5/3, and 3, respectively. For PVF in chloroform, we extracted an n value of 1.99, which is consistent with ⊖ conditions for the solution (ν=0.5) and the Gaussian coil. However, when PVF was combined with pyrrole, n was found to be 1.67, indicating a transformation into swollen coils. This change in chain conformation was attributed to interactions between the PVF coils and pyrrole monomers, presumably through the π-π stacking. In this way, pyrrole monomers extended the PVF chains in solution, swelling the PVF coil. An increase in the measured radius of gyration (R_{g}) again confirmed the structural change of PVF in solution. To obtain R_{g} for the polymer, partial Zimm plots were prepared (FIG. 26 inset). Here, a Lorentzian form for the Q-dependence of the scattering intensity was assumed, as described above. In the low-Q region, it was used to estimate R_{g}, as described above.

UV-Vis spectroscopy was also used to investigate the interactions between the polymers. To substantiate the likelihood of the π-π stacking interactions between PVF and PPy, we used UV-vis spectroscopy to probe the molecular interactions between pyrrole monomer and PVF, both of which possess π-aromatic cyclic moieties, in solution. The ferrocene units in each repeating unit of PVF contain two cyclopentadiene rings and have a characteristic energy absorption band around 220 nm, corresponding to the π→π* transition. Each pyrrole molecule contains a 5-membered heterocyclic aromatic ring, exhibiting a characteristic peak around 210 nm. For simplicity, the UV-vis spectrum of ferrocene was studied, rather than that of PVF, along with the spectrum of pyrrole. The ferrocene absorption peak decreased significantly as the pyrrole concentration increased from 0 mM to 100 mM (FIG. 26, panel b). The decreased UV absorption intensity, or hypochromism, of ferrocene in the presence of pyrrole is commonly observed in molecules with π-π stacking interactions, which is a result of the intermolecular overlapping of p-orbitals in their π-conjugated systems. This significant suppression of the ferrocene absorption peak indicates intimate molecular interactions between pyrrole and ferrocene in solution, which could be a result of a greatly extended molecular packing between the cyclopentadiene rings in PVF and the heterocyclic aromatic ring in pyrrole.

Fourier transform infrared spectroscopy (FTIR) was used to study the interaction between pyrrole and PVF within the formed hybrid after the co-deposition process. Pure PVF shows characteristic peaks at 3081, 1105, 1023, 999, and 810 cm⁻¹ (FIG. 26, panel c). For electrochemically polymerized PPy, FTIR shows characteristic peaks at 1524, 1439, 1080, and 1012 cm⁻¹. In comparison, the co-deposited polymer hybrid exhibited a broad peak from 1000 to 1300 cm⁻¹, as a result of the overlap of the peaks from the PVF and the significantly higher content of PPy in the hybrid. However, the peak corresponding to the C—H stretching of the ferrocene units shifted from 3081 to 3104 cm⁻¹ in the hybrid compared to the pure PVF. Similarly, the two observed peaks at 1524 cm⁻¹ (C═C stretching) and 1439 cm⁻¹ (C—N stretching) in PPy shifted to 1535 cm⁻¹ and 1456 cm⁻¹ in the hybrid, respectively. This red-shift of peaks for the C═C stretching and C—N stretching in the pyrrole ring and the C—H stretching in ferrocene indicated that the interactions between π-electrons of the cyclopentadiene rings and the pyrrole still exist within the formed hybrid.

The mechanism of hybrid film structure formation was also probed. The electropolymerization of pyrrole starts with the oxidation of pyrrole monomers at the electrode surface to form cation radicals, followed by dimerization. Further oxidation of the dimers induces polymer chain growth, which occurs simultaneously with the formation of oligomers in solution. The nucleation of PPy on the electrode surfaces occurs when the length of the oligomeric chains surpasses the solubility limit. Here, the ferrocene groups of PVF, which are known to be associated closely with the pyrrole monomer in solution, may work as electron transfer mediators to facilitate the formation of the pyrrole cation radicals and pyrrole oligomers in the vicinity of these PVF chains. A mesoscopic phase separation may occur between the chloroform-rich phase and the pyrrole/oligopyrrole-rich phase as pyrrole monomers polymerize, with PVF partitioning preferentially into the pyrrole/oligopyrrole-rich phase, to contribute to the formation of the highly porous morphology. Although the exact mechanism of the porous film formation still remains unclear, preliminary results with other conducting polymer monomers that can have π-π stacking interactions with PVF indicate that this synthesis strategy can be generalized. We have electrochemically co-deposited PVF/polyindole hybrid and PVF/polyaniline hybrid. The surface morphologies of these hybrid films are significantly more porous than those of the electrochemically polymerized pure polyindole and pure polyaniline films. Further examination of these analogous systems is the subject of on-going research.

### INCORPORATION BY REFERENCE

All of the U.S. patents and U.S. patent application publications cited herein are hereby incorporated by reference.

### EQUIVALENTS

Those skilled in the art will recognize, or be able to ascertain using no more than routine experimentation, many equivalents to the specific embodiments of the invention described herein. Such equivalents are intended to be encompassed by the following claims.

We claim:

1. A composite material, comprising a conductive matrix; and an electrochemically active polymer.

2. The composite material of claim 1, wherein the conductive matrix comprises a fiber.

3. The composite material of claim 1, wherein the conductive matrix is porous.

4. The composite material of claim 1, wherein the thickness of the conductive matrix is from about 20 μm to about 500 μm.

5. The composite material of claim 1, wherein the electrochemically active polymer is a conducting polymer.

6. The composite material of claim 5, wherein the conducting polymer is selected from the group consisting of polyaniline, poly(o-toluidine), poly(o-methoxyaniline), poly(o-ethoxyaniline), poly(l-pyreneamine), poly(4-aminobenzoic acid), poly(1-aminoanthracene), poly(N-methylaniline), poly(N-phenyl-2-naphthylamine), poly(diphenylamine), poly(2-aminodiphenylamine), poly(o-phenylenediamine), poly(o-aminophenol), polyuminol, polypyrrole, poly(3,4-ethylenedioxypyrrole), poly(3,4-propylenedioxypyrrole), poly(N-sulfonatopropoxy-dioxypyrrole), polyindole, polymelatonin, polyindoline, polycarbazoles, polythiophene, poly(3,4-ethylenedioxythiophene), polyphenazine, poly(p-phenylene), and poly(phenylenevinylene).

7. The composite material of claim 1, wherein the electrochemically active polymer is a redox polymer.

8. The composite material of claim 7, wherein the redox polymer is selected from the group consisting of poly(tetrathiafulvalene), quinoline polymers, poly(vinylferrocene), and [Ru(2,2′-bipyridyl)2-(4-vinylpyridine)₅Cl]Cl.

9. The composite material of claim 1, wherein the electrochemically active polymer comprises a conducting polymer; and a redox polymer.

10. The composite material of claim 9, wherein the conducting polymer is polypyrrole; and the redox polymer is poly(vinylferrocene).

11. The composite material of claim 1, wherein the electrochemically active polymer has a molecular weight from about 10,000 g/mol to about 500,000 g/mol.

12. The composite material of claim 1, wherein the conductive matrix is conformally coated with the electrochemically active polymer.

13. The composite material of claim 1, wherein the electrochemically active polymer is a film.

14. The composite material of claim 13, wherein the film has a thickness from about 5 nm to about 200 nm.

15. The composite material of claim 1, wherein the electrochemically active polymer is a film; the conductive matrix is conformally coated with the electrochemically active polymer film; the electrochemically active polymer comprises a redox polymer; the redox polymer is polyvinylferrocene; and the density of ferrocene moieties on the conductive matrix is from about 0.2 nmol/cm² to about 1.8 nmol/cm².

16. The composite material of claim 1, wherein the electrochemically active polymer is nanoporous.

17. A fixed-bed flow reactor or a charge storage device comprising a composite material of claim 1.

18. A method of catalyzing a chemical transformation of a starting material to a product, comprising the steps of:
contacting in an electrochemical cell the starting material with a composite material of claim 1, thereby forming a reaction mixture;
applying to the reaction mixture an electrochemical potential, thereby forming a quantity of the product; and
after a period of time, removing the electrochemical potential.

19. A method, comprising the steps of:
contacting in an electrochemical cell a fluid with a composite material of claim 1, wherein the fluid comprises a plurality of ionic moieties, thereby forming a mixture; and
applying to the mixture an electrochemical potential, thereby adsorbing a quantity of the ionic moieties onto the composite material.

20. A method, comprising the steps of:
contacting in an electrochemical cell a conductive matrix with (i) an electrochemically active polymer, (ii) an electro-polymerizable monomer that, once polymerized, forms an electrochemically active polymer, or (iii) both (i) and (ii), thereby forming a deposition mixture; and
applying to the deposition mixture an electrochemical potential, thereby (i) depositing onto the conductive matrix the electrochemically active polymer, (ii) depositing onto the conductive matrix an electrochemically active polymer derived from the electro-polymerizable monomer, or (iii) depositing onto the conductive matrix a hybrid polymer.
